(19) United States
(12) Patent Application Publication
(10) Pub. No.: US 2026/0023511 A1
(43) Pub. Date: Jan. 22, 2026

(54) NON-TRANSITORY COMPUTER READABLE STORAGE MEDIUM STORING INFORMATION PROCESSING PROGRAM, AND INFORMATION PROCESSING SYSTEM

(71) Applicant: BROTHER KOGYO KABUSHIKI KAISHA, Nagoya (JP)

(72) Inventor: Masatoshi KADOTA, Takahama (JP)

(21) Appl. No.: 19/341,123

(22) Filed: Sep. 26, 2025

Related U.S. Application Data
(63) Continuation of application No. PCT/JP2024/010207, filed on Mar. 15, 2024.
(63) Continuation of application No. PCT/JP2024/010208, filed on Mar. 15, 2024.

(30) Foreign Application Priority Data
Mar. 30, 2023 (JP) 2023-055829
Mar. 30, 2023 (JP) 2023-055830

(51) Int. Cl. G06F 3/12

(52) U.S. Cl. CPC G06F 3/1228; G06F 3/1206; G06F 3/1287

(57) ABSTRACT

A non-transitory computer-readable storage medium storing an information processing program configured to, when executed, cause an information processing device to perform operations comprising obtaining first capability information, obtaining function restriction information of the printing device, converting the first capability information into second capability information based on the function restriction information, outputting the second capability information to OS standard printing software, obtaining first print data from the OS standard printing software, and transmitting second print data based on the first print data to the printing device.

### REFERENCE TO RELATED APPLICATIONS

This is a continuation application of International Application No. PCT/JP2024/010207 filed on Mar. 15, 2024, which claims priority from Japanese Patent Application No. 2023-055829 filed on Mar. 30, 2023 and of International Application No. PCT/JP2024/010208 filed on Mar. 15, 2024, which claims priority from Japanese Patent Application No. 2023-055830 filed on Mar. 30, 2023. The entire contents of the aforementioned applications are incorporated herein by reference.

### BACKGROUND ART

The present disclosures relate to non-transitory computer readable medium storing information processing program, information processing device and information processing system.

In companies and other organizations, there may be a need to restrict the printing functions using printers due to various circumstances. For example, there may be a desire to limit costly color printing or restrict single-sided printing to save printing paper.

As described in Patent Document 1, there is a known printing system where the printer vendor provides a printer driver that sends predetermined print data based on print setting information to the printing device, which then executes the printing process. In this printing system, the printer driver imposes restrictions on the print setting information to limit printing functions.

### SUMMARY

In recent years, operating systems (OS) having so-called driverless printing functions, which perform printing according to a specific printing standard without using printer drivers provided by printer vendors, are becoming more common. In this case, printing can be performed without installing a printer driver. In environments utilizing such driverless OS printing functions, it is not possible to flexibly restrict printing functions.

A need has arisen to provide an information processing program, and an information processing system that offer user-friendly printing restriction functions in environments utilizing driverless OS printing functions.

A non-transitory computer-readable storage medium storing an information processing program executable by a processor of an information processing device being loaded with an operating system (OS) that includes OS standard printing software. The information processing program is configured to, when executed by the processor in a state where the information processing program is registered as a virtual printing device in the OS standard printing software, cause the information processing device to perform operations comprising obtaining first capability information indicating capability of a printing device, obtaining function restriction information of the printing device, based on the obtained function restriction information, converting the obtained first capability information into second capability information, outputting the second capability information obtained in the converting to the OS standard printing software, obtaining, from the OS standard printing software, first print data corresponding to the second capability information outputted in the outputting, transmitting, to the printing device, second print data based on the first print data obtained from the OS standard printing software.

According to the present disclosure, it is possible to provide easy to manage printing restriction functions in environments utilizing driverless OS printing functions.

### BRIEF DESCRIPTION OF THE DRAWINGS

FIG. 1 is a block diagram representing an example of the system configuration of a printing system and the functional configuration of a terminal device according to the first embodiment.

FIG. 2 is a diagram representing an example of the setting screen for a rule file stored in the rule storage.

FIG. 3 is a flowchart representing an example of the control procedure executed by the attribute/mDNS converter of the printer application in the terminal device according to the first embodiment.

FIG. 4 is a flowchart representing an example of the control procedure executed by the print data converter of the printer application in the terminal device according to the first embodiment.

FIG. 5 is a block diagram representing an example of the system configuration of a printing system and the functional configuration of a terminal device according to the second embodiment.

FIG. 6 is a flowchart representing an example of the control procedure related to the conversion of PPD files and attributes executed by the print data converter of the printer application in the terminal device according to the second embodiment.

FIG. 7 is a diagram representing an example of the setting screen for a rule file in a modification example where a response to errors is set in the rule file.

FIG. 8 is a flowchart representing an example of the control procedure executed by the print data converter of the printer application in the terminal device when the error response is set to error stop on the rule file setting screen.

FIG. 9 is a flowchart representing an example of the control procedure executed by the print data converter of the printer application in the terminal device in a modification example where the user selects print cancellation or data conversion after the error is displayed.

FIG. 10 is a block diagram representing an example of the hardware configuration of the terminal device and printer.

FIG. 11 is a block diagram representing an example of the system configuration of a printing system and the functional configuration of a terminal device according to the third embodiment.

FIG. 12 is a diagram representing an example of the setting screen for a rule file stored in the rule storage.

FIG. 13 is a block diagram representing an example of the filter function related to the user and attributes of the printer application in the terminal device.

FIG. 14 is a flowchart representing an example of the control procedure executed by the attribute/mDNS converter of the printer application in the terminal device according to the third embodiment.

FIG. 15 is a flowchart representing an example of the control procedure executed by the print data converter of the printer application in the terminal device according to the third embodiment.

FIG. 16 is a flowchart representing an example of the control procedure executed when the processor of the management PC sends rule files to each terminal device.

FIG. 17 is a diagram representing an example different from the EWS method for sending rule files from the management PC to the terminal device.

FIG. 18 is a diagram representing an example different from the EWS method for sending rule files from the management PC to the terminal device.

FIG. 19 is a diagram representing an example different from the EWS method for sending rule files from the management PC to the terminal device.

FIG. 20 is a block diagram representing an example of the hardware configuration of the terminal device and printer.

FIG. 21 is a block diagram representing an example of the hardware configuration of the management PC.

### DESCRIPTION

### First Embodiment

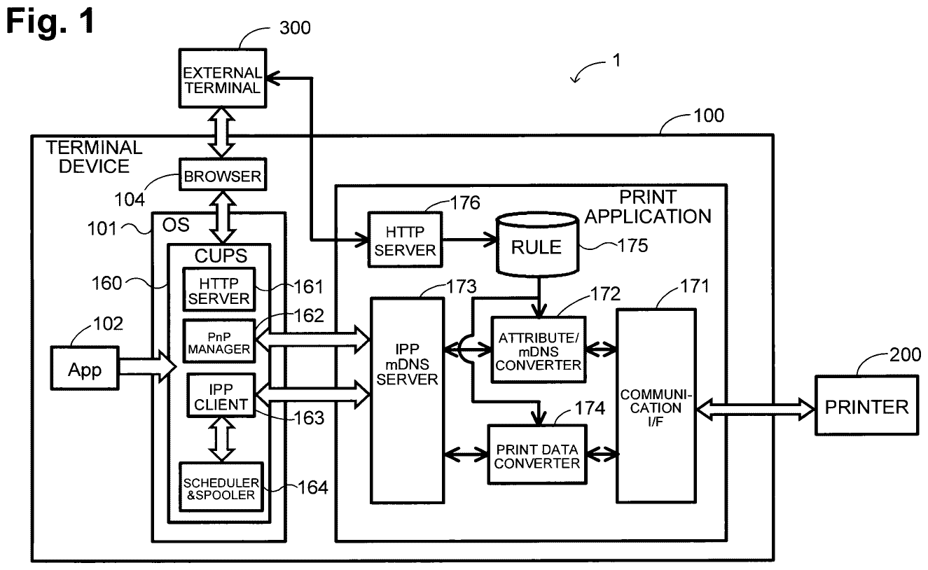

Embodiments of the present invention will be described with reference to the drawings. First, a first embodiment of the present invention will be described with reference to FIGS. 1 to 4. The first embodiment is an embodiment in which the printer 200 supports the Internet Printing Protocol (IPP).

### <Overview of the Printing System>

FIG. 1 shows an example of the system configuration of a printing system 1 according to the first embodiment. In FIG. 1, the printing system 1 includes a terminal device 100 and a printer 200. The terminal device 100 and the printer 200 are communicatively connected via the Internet, a wired LAN, or a wireless LAN, for example. Note that the terminal device 100 is an example of an information processing device, and the printer 200 is an example of a printing device.

### <Functional Configuration of the Terminal Device>

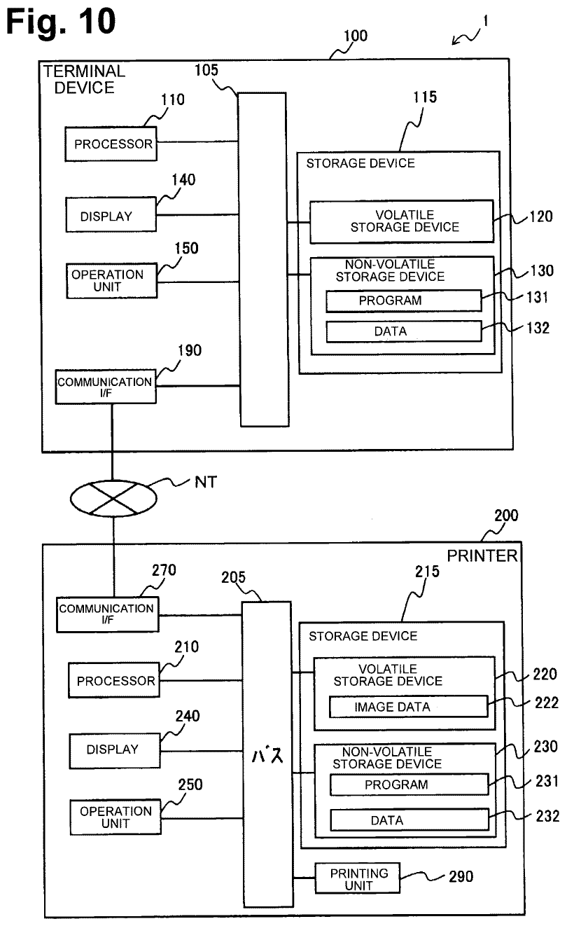

The terminal device 100 sends print data to the printer 200 to execute printing. The terminal device 100 may be a desktop PC, a notebook PC, a tablet computer, or a mobile terminal such as a smartphone. As will be described in detail later, the terminal device 100 includes a processor 110 and a storage device 115 that stores various print processing programs (see FIG. 10 described later). By executing various print processing programs, the processor 110 causes the terminal device 100 to have the functional configuration shown in FIG. 1. The print processing program is an example of an information processing program.

As shown in FIG. 1, the terminal device 100 includes an operating system (OS) 101, an editing application 102, a printer application 170, and a browser 104. The OS 101 has a so-called driverless printing function that performs printing without using a printer driver, according to a predetermined printing standard. The OS 101 includes, as an example, a modularized printing system for the OS, known as the Common UNIX Printing System (CUPS) 160. The CUPS 160 includes an HTTP server 161, a CUPS PnP manager 162, an IPP client 163, and a print data scheduler and spooler 164. The HTTP server 161 is server software that operates on the CUPS 160. The HTTP server 161 acquires information and functions input by the operator of the terminal device 100 or provides information and functions to the operator of the terminal device 100 using the Hypertext Transfer Protocol (HTTP) via the browser 104. The CUPS PnP manager 162 has a Plug and Play (PnP) function that registers detected printers (including virtual printing devices) with the CUPS 160 and creates a print queue, using protocols such as multicast Domain Name System/Service Directory (mDNS/SD). The CUPS PnP manager162 is configured to restrict the search address for PnP to the internal network of the terminal device 100 (usually the IP address 127.0.0.1) by a script executed during the installation of the printer application 170. Therefore, the CUPS 160 cannot directly recognize the printer 200 and recognizes the printer application 170 as a printer. The printer application 170 is not a real printer but a so-called virtual printer that behaves as a printer to the CUPS 160. By mediating between the CUPS 160 and the printer 200, the printer application 170 enables printing using the CUPS 160 and the printer 200. The IPP client 163 sends and receives print data or attributes using the IPP protocol with an IPP/mDNS server 173, described later. The print data scheduler and spooler 164 manage print jobs sent from the editing application 102 and other sources, temporarily holding multiple print jobs that occur simultaneously, and sequentially processing the print jobs to pass to the IPP client 163. Note that the CUPS 160 is an example of standard OS printing software.

The printer application 170 can be registered with CUPS 160 as a virtual printer corresponding to the connected printer 200. CUPS 160 treats the printer application 170 as a virtual printer and executes various processes related to printing. The various processes include, for example, capability information retrieval and print data transmission. The printer application 170 includes a printer communication unit 171, an attribute/mDNS converter 172, an IPP/mDNS server 173, a print data converter 174, a rule storage 175, and an HTTP server 176.

The printer communication unit 171 communicates with the printer 200 using the IPP protocol. The printer communication unit 171 receives attributes from the printer 200 and sends print data to the printer 200. The attribute/mDNS converter 172 obtains attributes representing the capabilities of the printer 200 via the printer communication unit 171 and retrieves the first rule file from the rule storage 175 to restrict the printing functions of the printer 200. The attribute/mDNS converter 172 converts the attributes obtained from the printer 200 into restricted attributes according to the first rule file obtained from the rule storage 175, thereby limiting some of the printer's functions. The attributes before conversion by the attribute/mDNS converter 172 are an example of the first capability information, and the attributes after conversion are an example of the second capability information.

The rule storage 175 stores rule files, which are information used to restrict the printing functions of the printer 200. The rule files include, for example, a first rule file and a second rule file. The first rule file contains rules that are commonly applied to all users of the printer 200. The printing function restrictions specified by the first rule file can be implemented through the conversion of attributes. The second rule file contains rules that are individually applied to each user of the printer 200. The printing function restrictions specified by the second rule file can be implemented through the conversion of print data, and these are restrictions that cannot be achieved through attribute conversion, for example. The rule files are examples of function restriction information. The first rule file being an example of the first restriction information and the second rule file being an example of the second restriction information. Rule files can be set, for instance, on an external terminal 300, which is an administrator's terminal of the printing system 1. The HTTP server 176 of the printer application 170 retrieves rule files set via a browser or similar tool on the external terminal 300 and stores the rule files in the rule storage 175. The rule storage 175 may be a part of the data storage area 132 of the non-volatile storage device 130 in the storage device 115 of the terminal device 100 (see FIG. 10 described later). Rule files can also be set on external terminals other than the administrator terminal and obtained from those external terminals. Additionally, the rule files can be set on the terminal device 100, or pre-configured contents can be installed in the printer application 170.

Note that the attribute/mDNS converter 172 has the functionality of mDNS (multicast Domain Name System). According to mDNS, the attribute/mDNS converter 172 broadcasts DNS queries via IP (Internet Protocol) multicast within a local network, simultaneously querying all devices on the same network. Devices that receive the query respond by sending their own IP addresses.

The IPP/mDNS server 173 outputs the attributes converted by the attribute/mDNS converter 172 to CUPS 160 in response to the capability information retrieval process of CUPS 160. Furthermore, the attribute/mDNS converter 172 controls the IPP/mDNS server 173 according to the first rule file, modifying the attributes to restrict functions according to the rules. By limiting the information related to mDNS/SD emitted from the IPP/mDNS server 173 in accordance with the rule file, it is also possible to prevent CUPS 160 from recognizing printers with specific functions, thus rendering the printers unusable. The CUPS PnP manager 162 does not register print queues via PnP for printers whose mDNS/SD information is restricted.

CUPS 160 outputs print data corresponding to the attributes converted by the IPP client 163. The IPP/mDNS server 173, in response to the print data transmission process of CUPS 160, retrieves the print data corresponding to the converted attributes output by CUPS 160 and sends the print data to the print data converter 174. Additionally, the IPP/mDNS server 173 has mDNS functionality similar to the attribute/mDNS converter 172.

The print data converter 174 converts the print data obtained from CUPS 160 by the IPP/mDNS server 173 into print data with some printing functions of the printer 200 restricted, according to the second rule file obtained from the rule storage 175. In this embodiment, the conversion of the print data is referred to as “data content conversion” to distinguish it from “data format conversion,” which will be described later. Additionally, the print data converter 174 performs “data format conversion,” converting the data format of the print data obtained from CUPS 160 (e.g., PWGRaster) into a predetermined data format (e.g., PCL) that the printer 200 can process. Specifically, the print data converter 174 determines whether the print data obtained from CUPS 160 is consistent with the second rule file. If the print data converter 174 determines that the print data is consistent with the second rule file, it executes only the “data format conversion” without performing the “data content conversion.” In this case, the print data converter 174 outputs the print data with the converted data format to the printer communication unit 171. On the other hand, if the print data converter 174 determines that the print data obtained from CUPS 160 is not consistent with the second rule file, it executes both the “data content conversion” and the “data format conversion.” In this case, the print data converter 174 outputs the print data with both the data content and data format converted to the printer communication unit 171. Note that the print data obtained from CUPS 160 is an example of the first print data, and the print data subjected to the “data content conversion” is an example of the second print data.

The printer communication unit 171 transmits the print data output from the print data converter 174 to the printer 200.

### <Rule File Setting Screen>

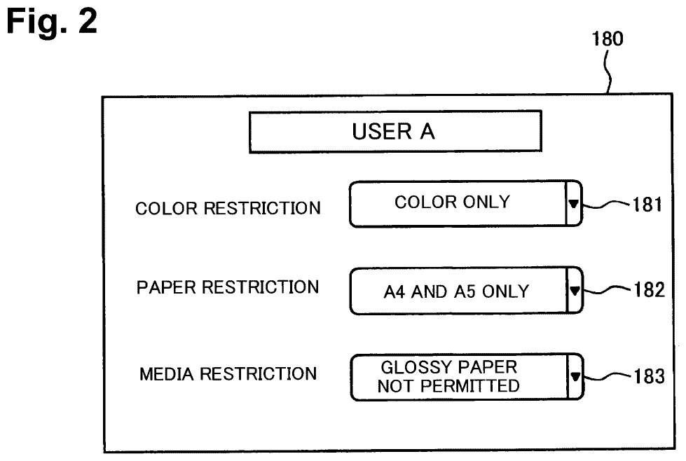

FIG. 2 shows an example of the rule file setting screen 180 stored in the rule storage 175. This setting screen 180 is displayed, for instance, on the browser of an external terminal 300, which is the administrator's terminal of the printing system 1, by accessing the IP address of the terminal device 100 and the port number used by the HTTP server 176.

The setting screen 180 shown in FIG. 2 is the configuration screen for the second rule file, which is individually applied to users using printer 200. On the setting screen 180, for example, user A has settings applied such as a color restriction limiting printing to color only, a paper restriction limiting paper size to A4 or A5 only, and a media restriction prohibiting the use of glossy paper. The method for inputting configuration settings is not particularly limited; however, in FIG. 2, for instance, when each setting button 181, 182, 183 is operated, a dropdown menu is displayed, allowing the user to select and set options from the dropdown menu. Additionally, when each setting button 181, 182, 183 is operated, a detailed setting screen may be displayed, where settings can also be configured.

It should be noted that the above restriction items are merely examples, and other restriction items may also be configured. Additionally, the first rule file, which is commonly applied to all users of printer 200, can be configured using a similar setting screen. The information configured on this screen is sent to the HTTP server 176 via the HTTP protocol and stored as a rule file.

### <Attribute/mDNS Conversion Unit Processing>

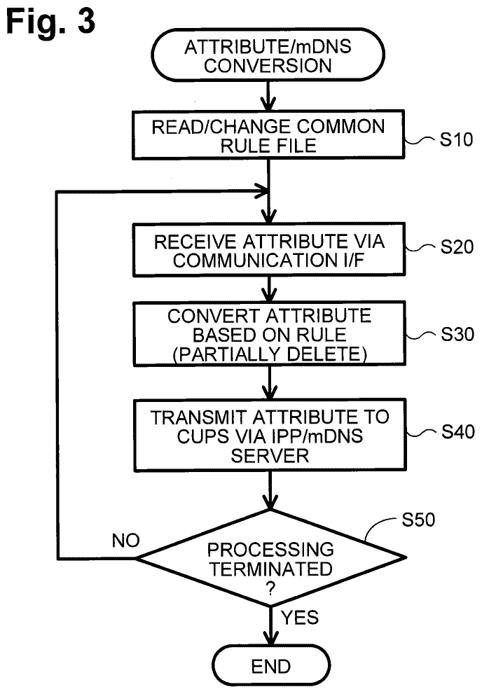

An example of the control procedure executed by the attribute/mDNS converter 172 of the printer application 170 in the terminal device 100 is explained using the flowchart in FIG. 3.

As shown in FIG. 3, in step S10, the attribute/mDNS converter 172 reads the first rule file, which is commonly applied to all users of printer 200, from the rule storage 175 and updates the first rule file. In other words, the attribute/mDNS converter 172 retrieves the rule file for printer 200. Step S10 is an example of the function restriction information acquisition process.

In step S20, the attribute/mDNS converter 172 receives attribute and mDNS/SD information from printer 200 via the printer communication unit 171. In other words, the attribute/mDNS converter 172 acquires attributes representing the capabilities of printer 200 and information regarding the existence of printer 200 itself. Step S20 is an example of the capability information acquisition process.

In step S30, the attribute/mDNS converter 172 converts the attribute and mDNS/SD information received in step S20 according to the first rule file read in step S10. For example, if color printing is restricted, the attribute/mDNS converter 172 deletes or changes the attribute indicating the capability for color printing to information indicating color printing is not allowed. Alternatively, the attribute/mDNS converter 172 may delete the mDNS/SD information indicating the presence of a color printer. In other words, the attribute/mDNS converter 172 transforms the attributes acquired in step S20 into attributes with restricted printing capabilities based on the first rule file obtained in step S10. StepS30 is an example of the capability information conversion process.

In step S40, the attribute/mDNS converter 172 sends the attributes converted in step S30 to CUPS 160 via the IPP/mDNS server 173. In other words, the attribute/mDNS converter 172 outputs the attributes converted in step S30 toward CUPS 160. Step S40 is an example of the capability information output process.

In step S50, the attribute/mDNS converter 172 determines whether the processing of all attributes and mDNS/SD information has been completed. If the processing of all attributes and mDNS/SD information has not been completed (step S50: No), the attribute/mDNS converter 172 returns to step S20. On the other hand, if the processing of all attributes and mDNS/SD information has been completed (step S50: Yes), the flow is terminated.

### <Processing of the Print Data Converter>

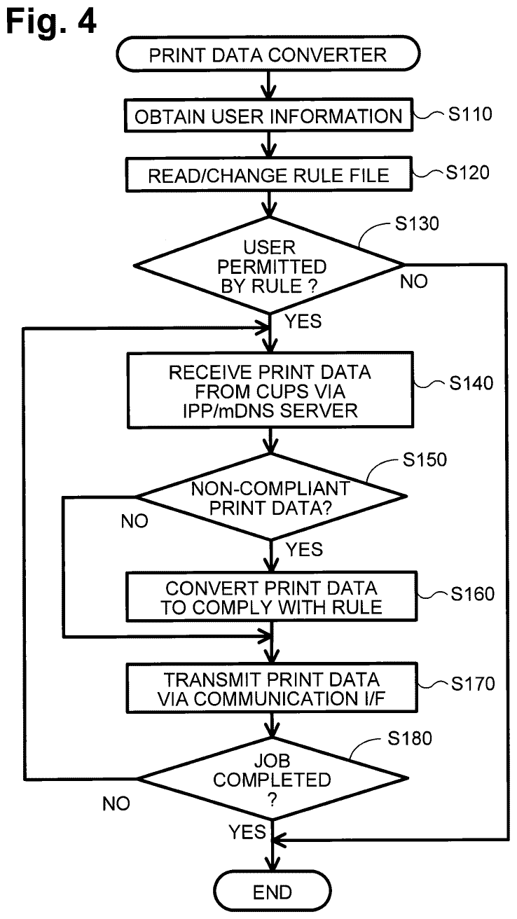

An example of the control procedure executed by the print data converter 174 of the printer application 170 in the terminal device 100 will be explained using the flowchart in FIG. 4.

As shown in FIG. 4, in step S110, the print data converter 174 acquires user information contained in the print data received from CUPS 160 via the IPP/mDNS server 173.

In step S120, the print data converter 174 reads the second rule file, which is individually applied to each user utilizing printer 200, from the rule storage 175 and updates the second rule file.

In step S130, the print data converter 174 determines whether the user related to the user information obtained in step S110 is an authorized user according to the second rule file read in step S120. Specifically, it checks whether the second rule file read in step S120 includes a rule file corresponding to the user related to the user information obtained in step S110. If the print data converter 174 determines that the user is not authorized (step S130: No), the flow is terminated. On the other hand, if the user is authorized (step S130: Yes), the process proceeds to the next step S140.

In step S140, the print data converter 174 receives print data from CUPS 160 via the IPP/mDNS server 173. In other words, the print data converter 174 acquires print data from CUPS 160 that corresponds to the converted attributes output in the aforementioned step S40. Step S140 is an example of the print data acquisition process.

In step S150, the print data converter 174 determines whether the print data received in step S140 falls outside the restrictions defined by the second rule file read in step S120. If the print data is within the restrictions of the second rule file (step S150: No), the print data converter 174 performs the aforementioned “data format conversion” on the print data and then proceeds to step S170, described later. On the other hand, if the print data is outside the restrictions of the second rule file (step S150: Yes), the process moves to the next step S160. In other words, the print data converter 174 checks whether the print data obtained in step S140 is consistent with the second rule file read in step S120. Step S150 is an example of a determination process.

In step S160, the print data converter 174 converts the print data received in step S140 according to the second rule file read in step S120. Here, the print data converter 174 performs the aforementioned “data content conversion” and “data format conversion” on the print data. In other words, the print data converter 174 converts the print data obtained from CUPS 160 in step S140 into print data with restricted printing functions based on the second rule file read in step S120. Step S160 is an example of the print data conversion process.

In step S170, the print data converter 174 sends the print data to the printer 200 via the printer communication unit 171. The print data to be sent is either the print data on which “data format conversion” was performed in step S150 (No) or the print data on which both “data content conversion” and “data format conversion” were performed in step S160. In other words, the print data converter 174 transmits the converted print data based on the print data obtained in step S140 to the printer 200. Step S170 is an example of the print data transmission process.

In step S180, the print data converter 174 determines whether the print job processed by CUPS 160 has been completed. If the print job has not been completed (step S180: No), the print data converter 174 returns to step S140. On the other hand, if the print job has been completed (step S180: Yes), the flow is terminated.

### Effects of the First Embodiment

In the printing system 1 of the first embodiment, the printer 200 is connected to the terminal device 100. When the print processing program of this embodiment is executed by the processor 110 of the terminal device 100, attributes representing the capabilities of the printer 200 are obtained in step S20, and a rule file for restricting the printing functions of the printer 200 is obtained in step S10. The attributes acquired in step S20 are converted into attributes with restricted printing functions according to the rule file obtained in step S10 during step S30. The converted attributes are output to CUPS 160 in step S40. CUPS 160 outputs print data corresponding to the converted attributes, and the output print data is acquired in step S140. The print data converted from the acquired print data is sent to the printer 200 in step S170, where printing based on the print data is executed.

By executing the above processes with the processor 110 of the terminal device 100 in the first embodiment, a virtual printing device is formed in the printer application 170 for CUPS 160, enabling driverless OS printing functionality to be utilized. CUPS 160 treats the printer application 170 as a pseudo-printer and performs various printing-related processes.

According to the first embodiment, by converting the attributes representing the capabilities of the printer 200 into attributes with restricted printing functions based on the rule file, the printing functions of the printer 200 can be limited. The first embodiment provides an easy to manage print restriction feature in environments that utilize driverless OS printing functionality. Additionally, it can prevent the recognition of the printer 200 itself as having specific functions.

In this embodiment, in particular, the rule file includes a first rule file for the printer 200. In step S30, the attributes obtained in step S20 are converted into attributes with restricted printing functions according to the first rule file obtained in step S10. The restriction of printing functions can be achieved either by converting the capability information of the printer 200 or by converting the print data. According to the first embodiment, it is possible to provide a print restriction function through the conversion of the attributes of the printer 200. For example, it is possible to toggle restrictions on functions supported by CUPS 160 based on the content of the attribute conversion of the printer 200.

Furthermore, in the first embodiment, the rule file specifically includes a first rule file that is commonly applied to all users of the printer 200. According to the first embodiment, it is possible to provide a print restriction function that is commonly applied to all users of the printer 200.

In the first embodiment, in particular, the print processing program instructs the processor 110 of the terminal device 100 to execute step S160, which converts the print data obtained from CUPS 160 into print data with restricted printing functions according to the second rule file. According to the first embodiment, in addition to converting the attributes into attributes with restricted printing functions according to the first rule file, it is also possible to convert the print data output by CUPS 160 into print data with restricted printing functions according to the second rule file. This embodiment allows for the provision of print restriction functions not only through the conversion of the printer 200's attributes but also through the conversion of print data, enabling comprehensive restriction of printing functions without omissions.

In the first embodiment, in particular, the rule file includes a second rule file for the printer 200. In step S160, the print data obtained in step S140 is converted into print data with restricted printing functions according to the second rule file obtained in step S120. The restriction of printing functions can be achieved either by converting the attributes of the printer 200 or by converting the print data. According to the first embodiment, it is possible to provide print restriction functions through the conversion of print data. For example, it is possible to toggle restrictions on functions that are not supported by CUPS 160 based on the content of the print data conversion.

In the first embodiment, in particular, the rule file includes a second rule file that is individually applied to each user of the printer 200. According to the first embodiment, it is possible to provide print restriction functions that are individually applied to each user of the printer 200.

Furthermore, in the first embodiment, the print processing program instructs the processor 110 of the terminal device 100 to execute step S150, which determines whether the print data obtained in step S140 conforms to the second rule file. According to the first embodiment, it is possible to execute different processes depending on whether the print data conforms to the second rule file.

In the first embodiment, in particular, if it is determined in step S150 that the print data conforms to the second rule file, step S160 is not executed, and instead, step S170 is executed. When the print data output by CUPS 160 conforms to the second rule file, the print restriction functions commonly applied to all users ensure that the individual print restrictions imposed on each user are satisfied, making conversion of the print data unnecessary. According to the first embodiment, by not executing unnecessary print data conversion processes, the processing load on the processor 110 of the terminal device 100 can be reduced.

In the first embodiment, in particular, if it is determined in step S150 that the print data does not conform to the second rule file, step S160 is executed. In step S170, the print data converted in step S160 is transmitted to the printer 200. According to this embodiment, if the print data output by CUPS 160 does not conform to the second rule file, it can be forcibly aligned with the second rule file through conversion. The first embodiment allows for meeting the needs of users who wish to prioritize executing prints even when printing functions are restricted.

### Second Embodiment

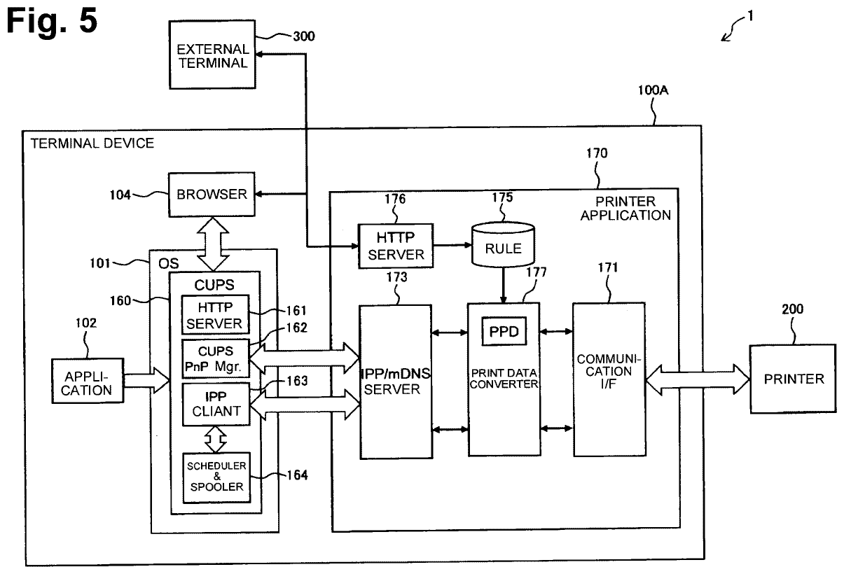

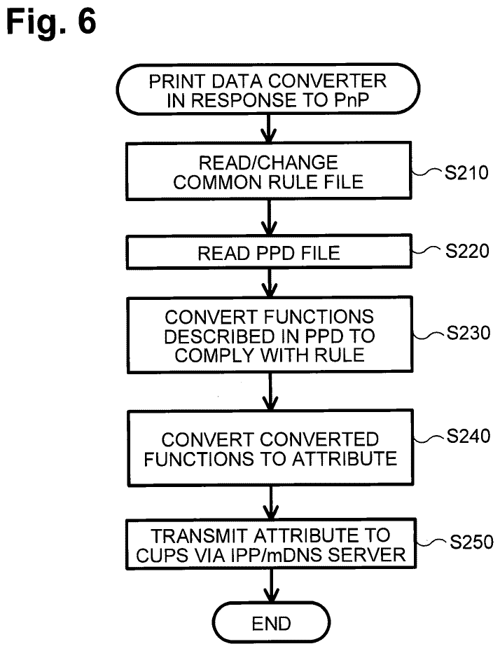

Next, the second embodiment of the present invention will be described with reference to FIGS. 5 to 6. The second embodiment pertains to a scenario where the printer 200 does not support the IPP protocol.

### <Functional Configuration of the Terminal Device>

FIG. 5 illustrates an example of the functional configuration of terminal device 100A according to the second embodiment. In FIG. 5, components that are similar to those in FIG. 1 of the first embodiment are denoted by the same reference numerals, and their explanations are omitted. The difference between terminal device 100A in the second embodiment and terminal device 100 in the first embodiment is that it includes a print data converter 177 instead of the attribute/mDNS converter 172 and the print data converter 174.

The print data converter 177 reads and acquires the PPD (PostScript Printer Description) file, which describes the functions or specifications of the printer 200, via the printer communication unit 171. Additionally, the print data converter 177 obtains a rule file from the rule storage 175 to restrict the printing functions of the printer 200. The print data converter 177 converts the PPD file obtained from the printer 200 into a PPD file that restricts some printing functions of the printer 200 according to the first rule file retrieved from the rule storage 175. Furthermore, the print data converter 177 converts the transformed PPD file into attributes. The PPD file before conversion by the print data converter 177 is an example of the first capability information, while the converted PPD file or attributes serve as an example of the second capability information.

The IPP/mDNS server 173 outputs the attributes converted from the PPD file by the print data converter 177 to CUPS 160. CUPS 160 then outputs print data corresponding to the converted attributes. The IPP/mDNS server 173 acquires the print data output by CUPS 160, which corresponds to the converted attributes, and outputs it to the print data converter 177.

The print data converter 177 performs “data content conversion,” which involves converting the print data obtained from CUPS 160 via the IPP/mDNS server 173 into print data that restricts some printing functions of the printer 200, according to the second rule file acquired from the rule storage 175. Additionally, the print data converter 177 performs “data format conversion,” which involves converting the data format of the print data obtained from CUPS 160 into a predetermined data format that the printer 200 can process. The processing procedure for converting print data by the print data converter 177 differs from that of the print data converter 174 in the first embodiment in terms of the predetermined data format that the printer 200 can ultimately process. The print data converter 177 determines whether the print data obtained from CUPS 160 conforms to the second rule file. If it determines that the print data from CUPS 160 conforms to the second rule file, the print data converter 177 executes only the “data format conversion” without performing the “data content conversion.” In this case, the print data conversion unit 177 outputs the print data with the converted data format to the printer communication unit 171. On the other hand, if the print data converter 177 determines that the print data obtained from CUPS 160 does not conform to the second rule file, it executes both the “data content conversion” and the “data format conversion.” In this case, the print data converter 177 outputs the print data with both the content and format converted to the printer communication unit 171.

The printer communication unit 171 transmits the print data output from the print data converter 177 to the printer 200.

### <Processing of the Print Data Converter>

An example of the control procedure related to the conversion of PPD files and attributes executed by the print data converter 177 in the printer application 170 of terminal device 100A is illustrated in the flowchart of FIG. 6.

As shown in FIG. 6, in step S210, the print data converter 177 reads the first rule file, which is commonly applied to all users of printer 200, from the rule storage 175 and updates the first rule file. In other words, the print data converter 177 acquires the rule file for printer 200. Step S210 is also an example of the function restriction information acquisition process.

In step S220, the print data converter 177 reads the PPD file pre-installed as a driver. In other words, the print data converter 177 acquires the PPD file representing the capabilities of printer 200. Step S220 is also an example of the capability information acquisition process.

In step S230, the print data converter 177 converts the functions described in the PPD file read in step S220 according to the first rule file read in step S210. For example, it restricts the printing functions of printer 200 by removing color printing and allowing only black-and-white printing. In other words, the print data converter 177 converts the PPD file obtained in step S220 into a PPD file with restricted printing functions according to the first rule file obtained in step S210. Step S230 is also an example of the capability information conversion process.

In step S240, the print data converter 177 converts the functions described in the PPD file transformed in step S230 into attributes.

In step S250, the print data converter 177 transmits the attributes converted in step S240 to CUPS 160 via the IPP/mDNS server 173. In other words, the print data converter 177 outputs the attributes converted in step S240 to CUPS 160. Step S250 is an example of the capability information output process. With this, the flow concludes.

The control procedure related to the conversion of print data executed by the print data converter 177 is similar to the content shown in FIG. 4 of the first embodiment described earlier, so the explanation is omitted. In the second embodiment described above, effects similar to those of the first embodiment can also be achieved.

### Modification Example

It should be noted that the present invention is not limited to the above embodiments, and various modifications can be made without departing from its spirit and technical concept.

### (1) Setting Responses to Errors in the Rule File

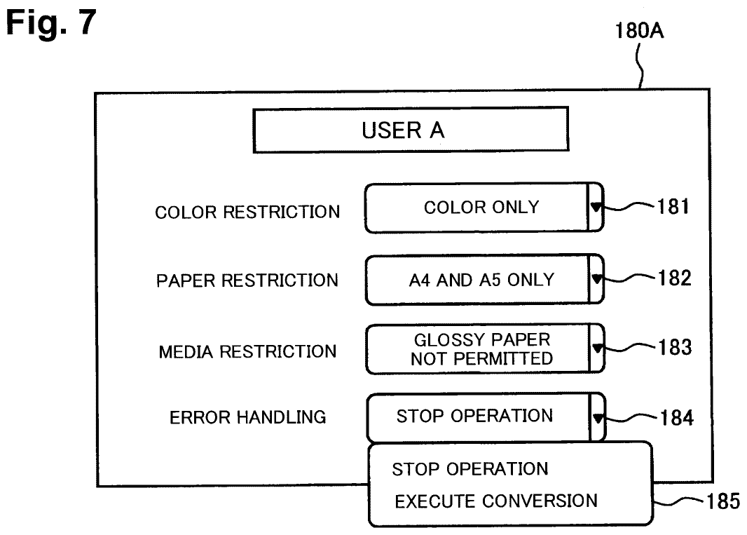

In the above, the second rule file was configured to set restrictions such as color, paper, and media limitations. However, it is also possible to set responses to errors. FIG. 7 shows an example of the rule file configuration screen 180A for this modification example. This configuration screen 180A is displayed, for example, on the browser of an external terminal 300, which is the administrator's terminal of the printing system 1, by accessing the IP address of the terminal device 100 and the port number used by the HTTP server 176.

The configuration screen 180A shown in FIG. 7 is a setup screen for the second rule file, which is individually applied to users utilizing printer 200. In configuration screen 180A, for example, user A can have error response settings in addition to the aforementioned color, paper, and media restrictions. The error response settings determine how to handle situations where the print data is deemed non-compliant with the second rule file in step S150 shown in FIG. 4. In the example shown in FIG. 7, users can choose between “Error Stop,” which displays an error message and halts printing, or “Conversion,” which forcibly adjusts the print data to align with the second rule file. By operating the setting button 184, users can display a pull-down menu 185 and select either “Error Stop” or “Conversion” from it. In the example shown in FIG. 7, “Error Stop” is selected. Additionally, when the setting button 184 is operated, a detailed configuration screen is displayed, where settings can also be adjusted.

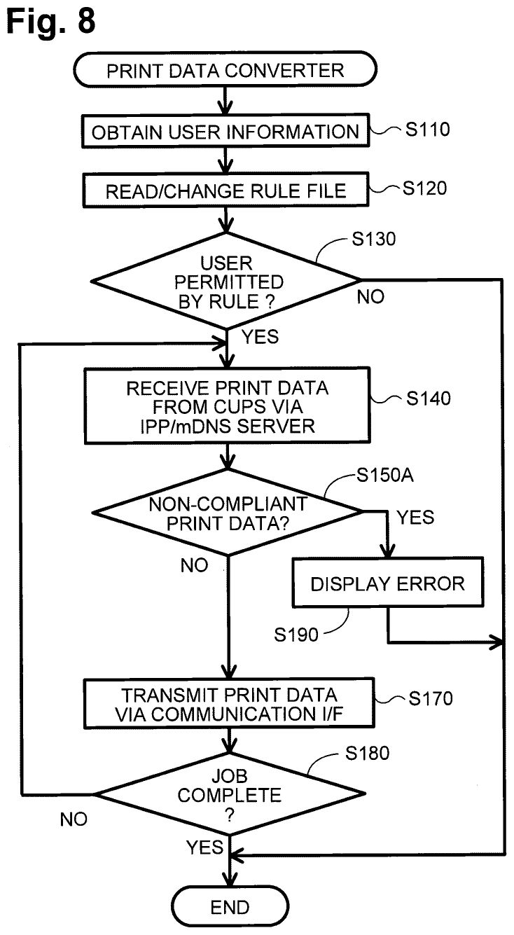

An example of the control procedure executed by the print data converter 174 of the printer application 170 in the terminal device 100 when the error response in the rule file configuration screen 180A is set to “Error Stop” is explained using the flowchart in FIG. 8. In FIG. 8, procedures similar to those in FIG. 4 of the first embodiment are assigned the same reference numbers, and their explanations are omitted.

Steps S110 to S140 in FIG. 8 are the same as those in FIG. 4 described earlier. In the next step, S150A, the print data converter 174 determines whether the print data received in step S140 falls outside the restrictions set by the second rule file read in step S120. If the print data is within the restriction range of the second rule file (step S150A: No), the print data converter 174 performs the aforementioned “data format conversion” on the print data and then proceeds to step S170. On the other hand, if the print data is outside the restriction range of the second rule file (step S150A: Yes), the print data converter 174 moves to the next step, S190. Step S150A is also an example of a decision-making process.

In step S190, the print data converter 174 displays the corresponding error message. This error message may inform the user of the restriction details, such as “You are restricted from color printing.” Step S190 is an example of the notification signal output process, and the display signal output to the display 140 of the terminal device 100 (see FIG. 10 described later) in step S190 is an example of a notification signal. Subsequently, the flow concludes without sending the print data to printer 200. Steps S170 to S180 are the same as those in FIG. 4 described earlier, so their explanation is omitted.

If the error response is set to “Conversion” in the rule file configuration screen 180A, the control procedure executed by the print data converter 174 of the printer application 170 in the terminal device 100 follows the flowchart shown in FIG. 4 described earlier.

In the modification example explained above, if it is determined in step S150A that the print data does not comply with the second rule file, a corresponding error notification is made in step S190. According to this modification, by notifying the user that the print data does not comply with the second rule file, the user can be prompted to review and adjust the print settings.

(2) Allowing the User to Select Between Canceling the Print or Converting the Data after an Error Message

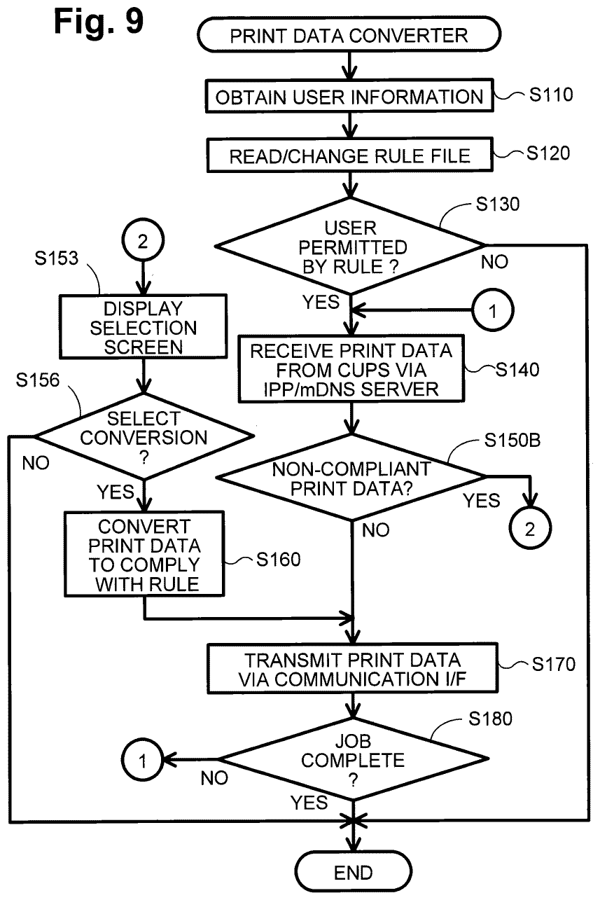

If the error response is set to “Error Stop” in the rule file configuration screen 180A, the system may allow the user to select whether to cancel the print or convert the print data after the error message is displayed. FIG. 9 shows an example of the control procedure executed by the print data converter 174 of the printer application 170 in the terminal device 100 in this modification example. In FIG. 9, the same reference numbers are used for procedures identical to those in FIG. 4 of the first embodiment, and their explanations are omitted.

Steps S110 to S140 in FIG. 9 are the same as those in FIG. 4 described earlier. In the next step, S150B, the print data converter 174 determines whether the print data received in step S140 falls outside the restrictions defined by the second rule file read in step S120. If the print data is within the restrictions of the second rule file (step S150B: No), the print data converter 174 executes the aforementioned “data format conversion” on the print data and then proceeds to step S170. On the other hand, if the print data falls outside the restrictions of the second rule file (step S150B: Yes), the process moves to the next step, S153. Step S150B is also an example of a decision-making process.

In step S153, the print data converter 174 displays the corresponding error message and also presents the conversion/cancel selection screen. The conversion/cancel selection screen allows the user to select whether to convert the print data or cancel the print. On this screen, the print data converter 174 accepts the user's selection to either abort the print or execute the conversion of the print data. Step S153 is an example of a selection acceptance process.

In step S156, the print data converter 174 determines whether the conversion was selected on the conversion/cancel selection screen. If cancel is selected (step S156: No), the print data converter 174 ends the flow without transmitting the print data to the printer 200. On the other hand, if conversion is selected (step S156: Yes), the process moves to the next step, S160.

In step S160, the print data converter 174 converts the print data received in step S140 according to the second rule file read in step S120, similar to the process described in FIG. 4. The subsequent steps, S170 to S180, are the same as those in FIG., so their explanation is omitted.

In the modification example described above, after executing the error notification in step S153, the system accepts the user's selection to either abort the print or execute the conversion of the print data. According to this modification example, if the print data does not conform to the second rule file, the user can choose to either cancel the print or convert the data into a restricted format, thereby providing an easy to manage print restriction feature.

### (3) Others

As mentioned earlier, CUPS 160 treats the printer application 170 as a virtual printer and executes printing-related processes. However, if the printer 200 is detected via the mDNS functionality provided by the attribute/mDNS converter 172 or the IPP/mDNS server 173, there is a possibility that CUPS 160 may also execute printing-related processes for printer 200. Therefore, the mDNS functionality provided by the attribute/mDNS converter 172 or the IPP/mDNS server 173 can be limited to the IP address of the IPP/mDNS server 173. This allows the browsing range for printers in the printing system 1 to be restricted to the IP address of the IPP/mDNS server 173, thereby preventing the detection of printer 200.

In the aforementioned embodiments and modification examples, the first rule file is a set of rules commonly applied to all users of printer 200, while the second rule file contains rules individually applied to each user of printer 200. However, this is not limiting. For instance, both the first and second rule files can be common to all users, or both can be individually applied to each user. In this case, the first rule file simply applies to functions that can be restricted by CUPS 160, and the second rule file applies to functions that can be restricted through the conversion of print data. Additionally, the second rule file may be applied individually to each terminal rather than each user.

The first embodiment is an embodiment where printer 200 supports the IPP protocol, and the second embodiment is an embodiment where printer 200 does not support the IPP protocol. However, a configuration combining both embodiments is also possible. Specifically, the printer application 170 can be structured to include both the attribute/mDNS converter 172 and the print data converter 174 from the first embodiment, as well as the print data converter 177 from the second embodiment. This allows users to utilize printers regardless of their IPP compatibility while still receiving the print restriction features.

In the first embodiment, the attribute and print data are converted according to the rule file, and in the second embodiment, the PPD file and print data are converted according to the rule file. However, this is not limiting. For example, it is possible to convert only the print data according to the rule file without converting the attribute or PPD file.

Additionally, the flowcharts shown in FIGS. 3 to 4, 6, and 8 to 9 do not limit the invention to the procedures indicated in these flows. Steps may be added, removed, or rearranged within the scope of the invention's spirit and technical concept.

Furthermore, the methods described in the above embodiments and their variations can be combined and used as needed.

Although not exhaustively illustrated here, various modifications can be made to the invention without departing from its spirit.

### <Hardware Configuration of the Terminal Device and Printer>

Using FIG. 10, an example of the hardware configuration of the terminal device 100 and printer 200 in the first and second embodiments will be described.

### <Terminal Device>

As shown in FIG. 10, the terminal device 100 includes a processor 110, a storage device 115, a display 140, an operation unit 150, and a communication interface 190. The processor 110, storage device 115, display 140, operation unit 150, and communication interface 190 are connected via a bus 105, allowing them to send and receive data with each other.

The storage device 115 includes a volatile storage device 120 and a non-volatile storage device 130. The volatile storage device 120 is, for example, a DRAM, which stores various programs and data to be processed. The non-volatile storage device 130 is, for example, a hard disk drive or a solid-state drive, and it includes a program storage area 131 and a data storage area 132.

Various programs are stored in the program storage area 131. These programs include the aforementioned print processing programs based on the flowcharts depicted in FIGS. 3 to 4, 6, and 8 to 9. The data storage area 132 stores data necessary for the execution of these various programs.

The processor 110 is a device for data processing, such as a CPU, and it executes various programs stored in the program storage area 131. The processor 110 performs various processes, including data communication with the printer 200 connected to the network NT. The processor 110 and the programs stored in the program storage area 131 are examples of a computing unit and a control unit.

The display 140 is, for example, an LCD display, capable of displaying various information. The operation unit 150 is, for example, a mouse or keyboard, which accepts user input. By operating the operation unit 150, the user can input various commands into the terminal device 100.

The communication interface 190 is an interface for communicating with other devices and is connected to the network NT. The communication interface 190 is an example of a communication I/F.

It should be noted that the storage device 115 is not limited to the components mentioned above. For example, it may be composed of RAM, ROM, EEPROM, HDD, portable recording media such as USB memory that can be attached and detached from the terminal device 100, buffers provided by the processor 110, or combinations thereof.

Additionally, the storage device 115 may be a computer-readable storage medium. A computer-readable storage medium is a non-transitory medium. Besides the examples mentioned above, non-transitory media include recording media such as CD-ROM and DVD-ROM. Non-transitory media are also tangible media. The same applies to the storage device 215 of the printer 200, which will be described later.

### <Printer>

As shown in FIG. 10, the printer 200 includes a processor 210, a storage device 215, a display 240, an operation unit 250, a communication interface 270, and a printing unit 290. These components of the processor 210, storage device 215, display 240, operation unit 250, communication interface 270, and printing unit 290, are connected via a bus 205, allowing them to send and receive data with each other.

The storage device 215 includes a volatile storage device 220 and a non-volatile storage device 230. The volatile storage device 220 is, for example, a DRAM, and it includes an image data storage area 222 for storing image data to be printed. The non-volatile storage device 230 is, for example, an NVRAM or flash memory, and it includes a program storage area 231 and a data storage area 232. Various programs are stored in the program storage area 231, including firmware such as print processing programs. The data storage area 232 stores various data necessary for executing these programs.

The processor 210 is a device for data processing, such as a CPU. The processor 210 executes the various programs stored in the program storage area 231.

The display 240 is, for example, an LCD display, capable of displaying various information. The operation unit 250 is a device that accepts user input. By operating the operation unit 250, the user can input various commands into the printer 200. The communication interface 270 is a wired or wireless network interface for communicating with other devices and is connected to the network NT.

The printing unit 290 prints images on sheets that are transported by a conveyance mechanism not shown in the diagram. The printing unit 290 prints images on sheets based on print data sent from the terminal device 100 or on print jobs generated by itself based on operations performed on the operation unit 250.

### Third Embodiment

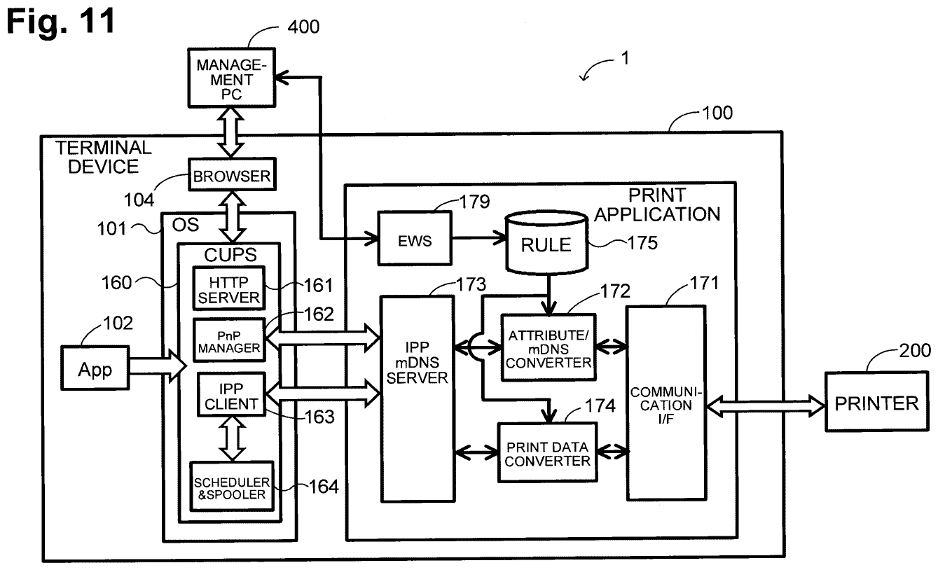

Next, the third embodiment of the present invention will be described with reference to FIGS. 11 to 16.

### <Overview of the Printing System>

FIG. 11 illustrates an example of the system configuration of terminal device 100B according to the third embodiment. In FIG. 11, components that are similar to those in FIG. 1 of the first embodiment are denoted by the same reference numerals.

In FIG. 11, the printing system 1 includes a terminal device 100B, a printer 200, and a management PC 400. The terminal device 100B and the printer 200 are communicatively connected, for example, via the internet, a wired LAN, or a wireless LAN. Similarly, the terminal device 100B and the management PC 400 are also communicatively connected via the internet, a wired LAN, or a wireless LAN. The combination of the terminal device 100B and the printer 200 within the printing system 1 can be a single pair or multiple pairs. Additionally, multiple printers 200 can be connected to a single terminal device 100B. It should be noted that the printing system 1 is an example of an information processing system, the terminal device 100B is an example of a first information processing device, the printer 200 is an example of a printing device, and the management PC 400 is an example of a second information processing device.

### <Functional Configuration of the Terminal Device>

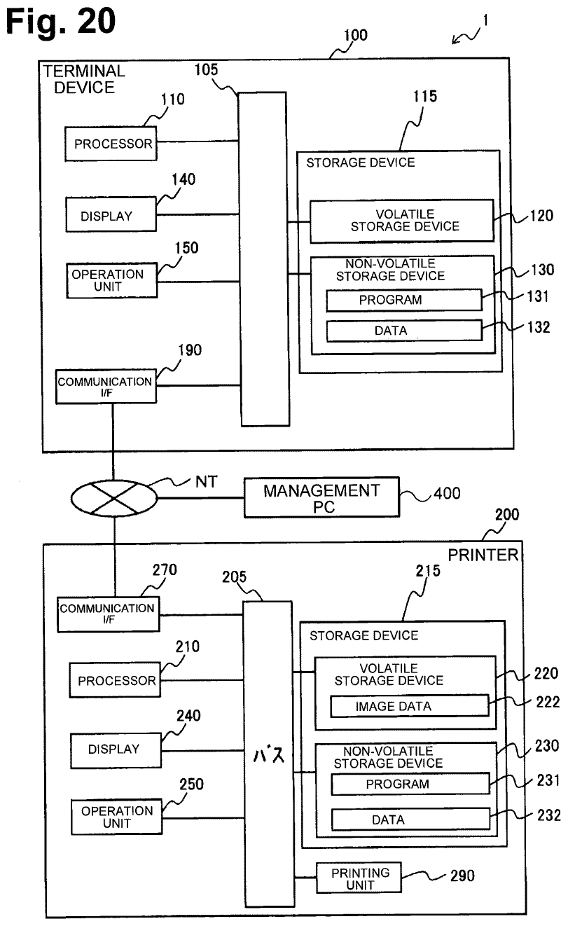

The terminal device 100B transmits print data to the printer 200 to execute printing. The terminal device 100B can be a desktop PC, a laptop PC, a tablet computer, or even a mobile device like a smartphone. As will be described in detail later, the terminal device 100B includes a processor 110 and a storage device 115 that stores various print processing programs (see FIG. 20 below). By executing these print processing programs, the processor 110 enables the terminal device 100B to have the functional configuration shown in FIG. 11.

As shown in FIG. 11, the terminal device 100B includes an Operating System (OS) 101, an editing application 102, a printer application 170, and a browser 104. The OS 101, for example, incorporates CUPS (Common Unix Printing System) 160, which provides a driverless printing function that allows printing according to a specific print standard without using printer drivers. CUPS 160 is a modular printing system for the OS, standardly equipped within OS 101, capable of executing driverless printing without using drivers provided by printer vendors. CUPS 160 includes an HTTP server 161, a CUPSPnP manager 162, an IPP client 163, and a print data scheduler and spooler 164. The HTTP server 161 is server software operating within CUPS 160. It uses the HTTP (Hypertext Transfer Protocol) protocol via the browser 104 to acquire information and functions input by the operator of the terminal device 100 or provide information and functions to the operator of the terminal device 100B.

The CUPSPnP manager 162 has a Plug and Play (PnP) function that registers detected printers (including virtual printing devices) using protocols like mDNS/SD into CUPS 160 to create print queues. During the installation of the printer application 170, a script is executed that changes the settings to restrict the search address for PnP to the internal network of the terminal device 100 (usually IP address 127.0.0.1). Consequently, CUPS 160 cannot directly recognize the printer 200 and instead recognizes the printer application 170 as a printer. The printer application 170 is not a physical printer but acts as a so-called virtual printer to CUPS 160. By mediating between CUPS 160 and the printer 200, the printer application 170 enables printing using CUPS 160 and the printer 200. The IPP client 163 sends and receives print data or attributes using the IPP protocol with the IPP/mDNS server 173, which will be described later. The print data scheduler and spooler 164 manage print jobs sent from the editing application 102 and other sources, temporarily holding multiple simultaneous print jobs and processing them sequentially to hand over to the IPP client 163. Note that CUPS 160 is an example of standard printing software for the OS.

The printer application 170 operates as a virtual printer corresponding to the printer 200 for CUPS 160. CUPS 160 treats the printer application 170 as a printer and executes various processes related to printing. The printer application 170 includes a printer communication unit 171, an attribute/mDNS converter 172, an IPP/mDNS server 173, a print data converter 174, a rule storage 175, and an EWS 179.

The printer communication unit 171 communicates with the printer 200 using the Internet Printing Protocol (IPP). The printer 200 is compatible with the IPP protocol. The printer communication unit 171 receives attributes from the printer 200 and sends print data to the printer 200.

The attribute/mDNS converter 172 obtains attributes representing the capabilities of the printer 200 via the printer communication unit 171 and retrieves rule files from the rule storage 175 to restrict the printing functions of the printer 200. The attribute/mDNS converter 172 converts the attributes obtained from the printer 200 into restricted attributes according to the rule files obtained from the rule storage 175, thereby limiting some of the printer's functions. The attributes before conversion by the attribute/mDNS converter 172 are an example of first capability information, and the converted attributes are an example of second capability information. The process by which the attribute/mDNS converter 172 converts attributes is an example of the first conversion process.

The rule storage 175 stores rule files, which are information used to restrict the printing functions of the printer 200. The printing function restrictions defined by the rule files include those that can be achieved through attribute conversion. These restrictions also include those that can be achieved through print data conversion, such as printing function restrictions that cannot be realized through attribute conversion alone. The rule file is an example of function restriction information.

For instance, the rule file can set restrictions such as limiting the print color to either color or black and white, restricting paper size to predetermined sizes like A4 or A5, and prohibiting the use of glossy paper through media restrictions.

The rule file is generated, for example, on the management PC 300 and transmitted to the terminal device 100 from the management PC 300. Alternatively, the rule file is generated by the printer application 170 of the terminal device 100 based on configuration information set via the management PC 300 or similar devices. The transmission method is not particularly limited, but in this embodiment, the printer application 170 includes an Embedded Web Server (EWS) 179. The EWS 179 displays a configuration screen via a browser on the management PC 300, collects configuration information about the functions to be restricted from this configuration screen to generate the rule file, or obtains the rule file from the management PC 300 using the HTTP protocol and stores it in the rule storage 175.

The attribute/mDNS conversion unit 172 has the functionality of mDNS (multicast Domain Name System). mDNS broadcasts DNS queries over IP (Internet Protocol) multicast within a local network, allowing all devices on the same network to receive the query simultaneously. Devices that receive the query respond by sending their IP address.

The IPP/mDNS server 173 outputs the attributes converted by the attribute/mDNS converter 172 to CUPS 160. Furthermore, the attribute/mDNS converter 172 controls the IPP/mDNS server 173 according to the rule file, modifying the attributes to restrict functions in compliance with the rules. By limiting the information related to mDNS/SD issued from the IPP/mDNS server 173 according to the rule file, it is possible to prevent CUPS 160 from recognizing specific-function printers, thereby rendering them unusable. The CUPS PnP manager 162 does not register print queues via PnP for printers with restricted mDNS/SD information.

CUPS 160 outputs print data corresponding to the converted attributes via the IPP client 163. The IPP/mDNS server 173 obtains the print data corresponding to the converted attributes output from CUPS 160 and sends it to the print data converter 174. The IPP/mDNS server 173, like the attribute/mDNS converter 172, also has mDNS functionality.

The process in which the attribute/mDNS converter 172 converts attributes, and the process in which the IPP/mDNS server 173 outputs the converted attributes to CUPS 160, are examples of capability information output processing.

The print data converter 174 converts the print data obtained from CUPS 160 by the IPP/mDNS server 173 into print data with restricted printing functions for the printer 200, according to the rule files obtained from the rule storage 175. In this embodiment, this conversion of print data is appropriately referred to as “conversion of data content” to distinguish it from the “conversion of data format” described later. Additionally, the print data converter 174 performs “conversion of data format” by converting the data format of the print data obtained from CUPS 160 (e.g., PWGRaster) into a predetermined data format (e.g., PCL) that the printer 200 can process. Specifically, the print data converter 174 determines whether the print data obtained from CUPS 160 aligns with the rule file. If the print data converter 174 determines that the print data aligns with the rule file, the print data converter 174 executes only the “conversion of data format” without performing the “conversion of data content.” In this case, the print data converter 174 outputs the print data with the converted data format to the printer communication unit 171. On the other hand, if the print data converter 174 determines that the print data obtained from CUPS 160 does not align with the rule file, the print data converter 174 executes both the “conversion of data content” and the “conversion of data format.” In this case, the print data converter 174 outputs the print data with both converted content and format to the printer communication unit 171. The print data obtained from CUPS 160 is an example of first print data, and the print data after “conversion of data format” or “conversion of data content” is an example of second print data. The process by which the print data converter 174 converts the print data obtained from CUPS 160 into print data according to the rule file is an example of the second conversion process.

The printer communication unit 171 transmits the print data output from the print data converter 174 to the printer 200. The process in which the print data converter 174 acquires print data from CUPS 160, converts the acquired print data into print data according to the rule file, and the printer communication unit 171 sends the converted print data to the printer 200 is an example of a print data transmission process.

### <Management PC>

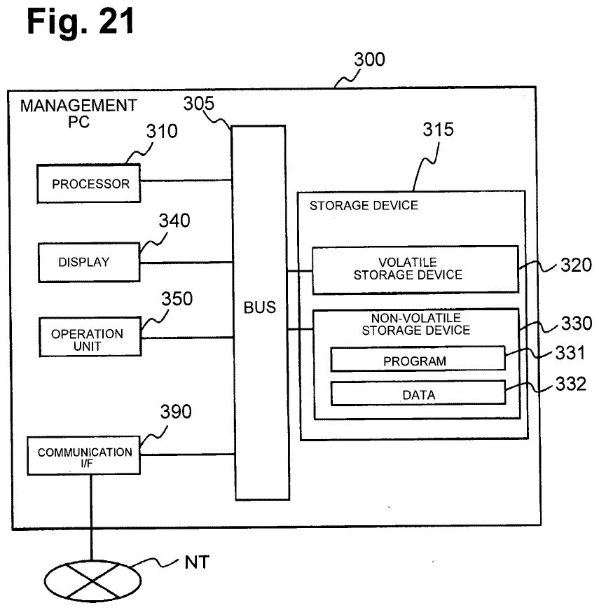

The management PC 400 is a terminal device used by the administrator of the printing system 1. The management PC 400 displays the configuration screen sent from EWS 179 via the browser or similar interface. Based on the configuration information for restricted functions entered from this configuration screen, EWS 179 generates a rule file. Alternatively, the rule file generated on the management PC 400 is sent to the printer application 170 of the terminal device 100B, and this rule file is stored in the rule storage 175. The management PC 400 can be a desktop PC, laptop, tablet computer, etc. As will be detailed later, the management PC 400 includes a processor 410 and a storage device 415 that stores various information processing programs (see FIG. 21 described later). The processor 410 executes various information processing programs.

### <Rule File Configuration Screen>

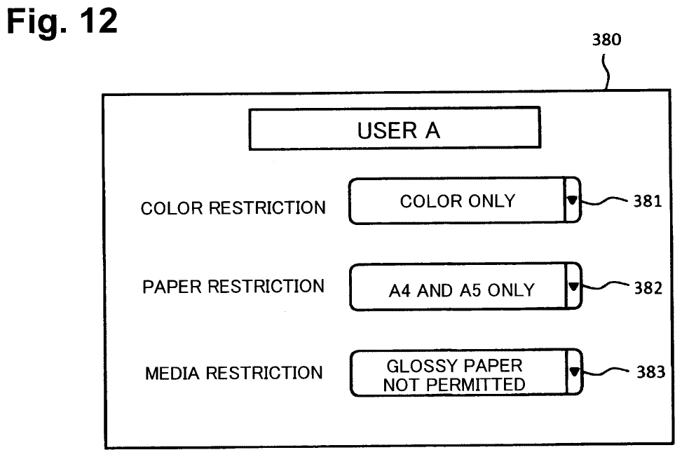

FIG. 12 shows an example of the configuration screen 380 for the rule file stored in the rule storage unit 175. This configuration screen 380 is displayed by accessing a specific URL of EWS 380 via a browser on the management PC 400.

The configuration screen 380 shown in FIG. 12 is used to set up rule files individually applied to users using printer 200. On the configuration screen 380, for example, user A has settings such as a color restriction limiting printing to color only, a paper restriction limiting paper size to A4 or A5, and a media restriction prohibiting the use of glossy paper. The method of entering these settings is not particularly limited, but in FIG. 12, for example, when each setting button 381, 382, 383 is operated, a pull-down menu is displayed, and settings are made by selecting from it. Additionally, when each setting button 381, 382, 383 is operated, a detailed settings screen may be displayed, and settings can also be made there.

These restriction items are examples, and other restriction items may also be set. A similar configuration screen can be used to set rule files that apply commonly to all users of printer 200. The information set on this screen is acquired by EWS 179 and stored as a rule file.

### <Filter Function of Printer Application>

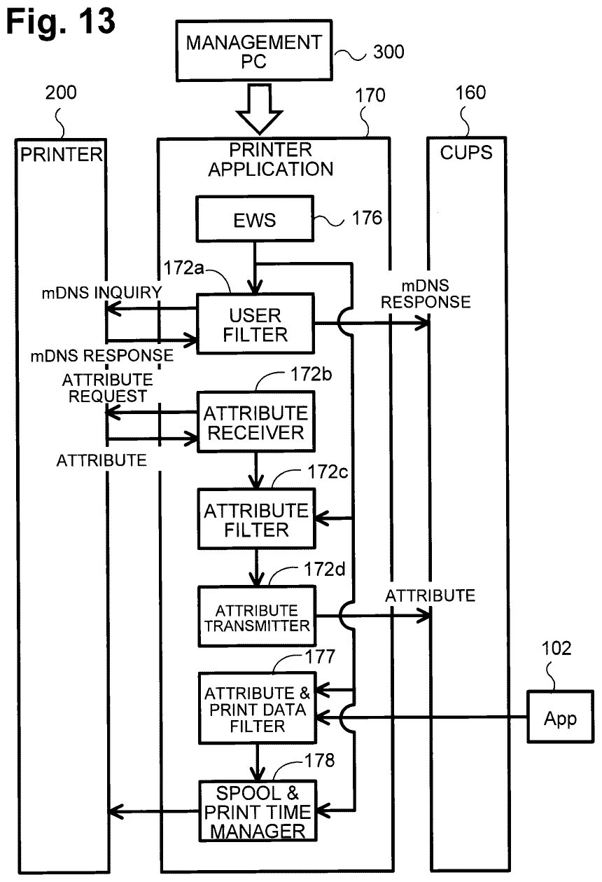

FIG. 13 illustrates an example of the filter function related to users and attributes in the printer application 170 of the terminal device 100B. As shown in FIG. 13, the printer application 170 includes the aforementioned EWS 179, a user filter 172a, an attribute receiver 172b, an attribute filter 172c, an attribute transmitter 172d, an attribute and print data filter 177, and a spool and print time manager 178. The user filter 172a, attribute receiver 172b, attribute filter 172c, and attribute transmitter 172d constitute the functions of the aforementioned attribute/mDNS converter 172.

EWS 179 outputs display data for the configuration screen used to set up rule files to the browser of the management PC 400 in HTML format when accessed via a designated URL through appropriate operations by the administrator on the management PC 400. EWS 179 is configured to allow access only from specific users, for example, through password authentication. When the administrator sets or modifies rule files on the displayed configuration screen, the configured rule files are generated via EWS 179 and stored in the rule storage 175 of the printer application 170. The rule files stored in the rule storage 175 are utilized by the user filter 172a, attribute filter 172c, attribute and print data filter 177, and spool and print time manager 178.

The user filter 172a narrows down the response information via mDNS to the allowed combinations of users and printer 200. Specifically, the attribute/mDNS converter 172 or the IPP/mDNS server 173 sends inquiry information via mDNS to all printers on the same network. The attribute/mDNS converter 172 acquires the response information sent from each printer in response to the inquiry information through the printer communication unit 171. The user filter 172a identifies the response information from printer 200, from which user access is restricted based on the content of the functional restrictions in the rule file. The user filter 172a does not output the response information from printers where user access is restricted to CUPS 160. In other words, in CUPS 160, it is as if those printers do not exist. On the other hand, response information from printers where user access is not restricted is output to CUPS 160.

The process in which the attribute/mDNS converter 172 or the IPP/mDNS server 173 sends inquiry information via mDNS is an example of an inquiry transmission process. The process in which the attribute/mDNS converter 172 receives response information is an example of a response reception process. The process where the user filter 172a does not output response information from printer 200 to CUPS 160 if it is from a printer with restricted user access, but outputs response information from other printers, is an example of a response information output process.

When the attribute/mDNS converter 172 sends an attribute request to printer 200, the attribute receiver 172b receives the attributes sent from printer 200 in response to the request. The attribute receiver 172b outputs the received attributes to the attribute filter 172c. The attribute filter 172c converts the received attributes into attributes with certain printing functions restricted, based on the rule file acquired via EWS 179. The attribute filter 172c outputs the converted attributes to the attribute transmitter 172d. The attribute transmitter 172d sends the converted attributes to CUPS 160 via the IPP/mDNS server 173.

The attribute & print data filter 177 receives print jobs sent from the editing application 102 via CUPS 160. The attribute & print data filter 177 modifies the destination information of the received print jobs according to the rule file obtained from EWS 179 and outputs the print jobs to the spool and print time manager 178. The spool and print time manager 178 manages the print timing of the print jobs and temporarily holds multiple print jobs to execute sequential transmission processing. The print jobs include print data. The attribute & print data filter 177 and the spool and print time manager 178 are positioned, for example, between the print data converter 174 and the printer communication unit 171 as shown in FIG. 11.

### <Processing of the Attribute/mDNS Conversion Unit>

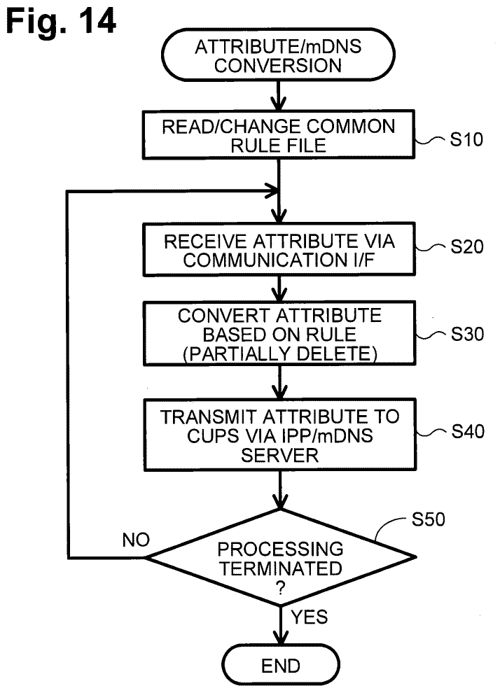

An example of the control procedure executed by the attribute/mDNS converter 172 of the printer application 170 in terminal device 100B is illustrated in the flowchart of FIG. 14. This flowchart corresponds to the attribute filter 172c shown in FIG. 13.

As shown in FIG. 14, in step S10, the attribute/mDNS converter 172 reads the rule file that is commonly applied to all users of printer 200 from the rule storage 175 and updates the rule file. In other words, the attribute/mDNS converter 172 acquires the rule file for printer 200.

In step S20, the attribute/mDNS converter 172 receives attribute and mDNS/SD information from printer 200 via the printer communication unit 171. In other words, the attribute/mDNS converter 172 acquires information representing the capabilities of printer 200 as well as information about the existence of printer 200 itself. This step S20 is an example of a capability information acquisition process.

In step S30, the attribute/mDNS converter 172 converts the attribute and mDNS/SD information received in step S20 according to the rule file read in step S10. For example, if color printing is restricted, the attribute indicating that color printing is available is either removed or changed to indicate that it is not available. Alternatively, the mDNS/SD information indicating the existence of a color printer is deleted. Additionally, if paper size is restricted to A4 and A5, the attribute/mDNS converter 172 will limit the paper size attributes to only A4 and A5. Furthermore, if there is a media restriction such as the prohibition of glossy paper, the attribute related to media will exclude glossy paper. In other words, the attribute/mDNS converter 172 converts the attributes acquired in step S20 into attributes with restricted printing functions according to the rule file acquired in step S10. This step S30 is an example of the first conversion process.

In step S40, the attribute/mDNS converter 172 sends the attributes converted in step S30 to CUPS 160 via the IPP/mDNS server 173. In other words, the attribute/mDNS converter 172 outputs the attributes converted in step S30 to CUPS 160. Steps S30 and S40 are examples of capability information output processing.

In step S50, the attribute/mDNS converter 172 determines whether the processing of all attributes and mDNS/SD information is complete. If the processing is not complete (step S50: No), the attribute/mDNS converter 172 returns to step S20. On the other hand, if the processing of all attributes and mDNS/SD information is complete (step S50: Yes), the flow ends.

### <Processing of the Print Data Converter>

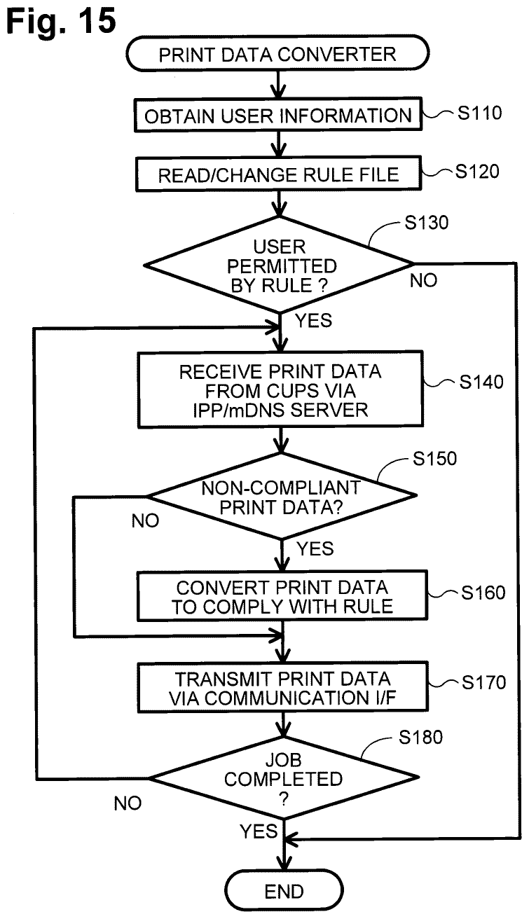

An example of the control procedure executed by the print data converter 174 of the printer application 170 in terminal device 100B is illustrated in the flowchart of FIG. 15.

As shown in FIG. 15, in step S110, the print data converter 174 acquires user information contained in the print data received from CUPS 160 via the IPP/mDNS server 173.

In step S120, the print data converter 174 reads the rule file, which is applied individually to each user of printer 200, from the rule storage 175 and updates the rule file.

In step S130, the print data converter 174 determines whether the user associated with the user information acquired in step S110 is an authorized user according to the rule file read in step S120. Specifically, it checks whether the rule file read in step S120 contains a rule file corresponding to the user associated with the user information obtained in step S110. If the user is not authorized (step S130: No), the print data converter 174 ends the flow. On the other hand, if the user is authorized (step S130: Yes), it proceeds to the next step S140. This step S130 corresponds to the user filter 172a shown in FIG. 13.

In step S140, the print data converter 174 receives print data from CUPS 160 via the IPP/mDNS server 173. In other words, the print data converter 174 acquires print data from CUPS 160 that corresponds to the converted attributes output in the aforementioned step S40.

In step S150, the print data converter 174 determines whether the print data received in step S140 falls outside the restrictions of the rule file read in step S120. If the print data is within the restrictions of the rule file (step S150: No), the print data converter 174 performs the aforementioned “data format conversion” on the print data and then proceeds to step S170, which will be described later. On the other hand, if the print data falls outside the restrictions of the rule file (step S150: Yes), the print data converter 174 proceeds to the next step S160. In other words, the print data converter 174 determines whether the print data acquired in step S140 is consistent with the rule file read in step S120.

In step S160, the print data converter 174 converts the print data received in step S140 according to the rule file read in step S120. Here, the print data converter 174 performs the aforementioned “data content conversion” and “data format conversion” on the print data. In other words, the print data converter 174 converts the print data acquired from CUPS 160 in step S140 into print data with restricted printing functions based on the rule file read in step S120. This step S160 is an example of the second conversion process and corresponds to the attribute & print data filter 177 shown in FIG. 13.

In step S170, the print data converter 174 transmits the print data to printer 200 via the printer communication unit 171. The print data transmitted is either the print data on which “data format conversion” was performed in step S150 (No) or the print data on which “data content conversion” and “data format conversion” were performed in step S160. In other words, the print data converter 174 transmits the converted print data based on the print data acquired in step S140 to printer 200. Steps S140 to S170 are an example of print data transmission processing.

In step S180, the print data converter 174 determines whether the print job processed by CUPS 160 has been completed. If the print job has not been completed (step S180: No), the print data converter 174 returns to step S140. On the other hand, if the print job has been completed (step S180: Yes), the flow ends.

Steps S30 and S160 are examples of restriction processing.

### <Transmission Process of Rule Files by Management PC>

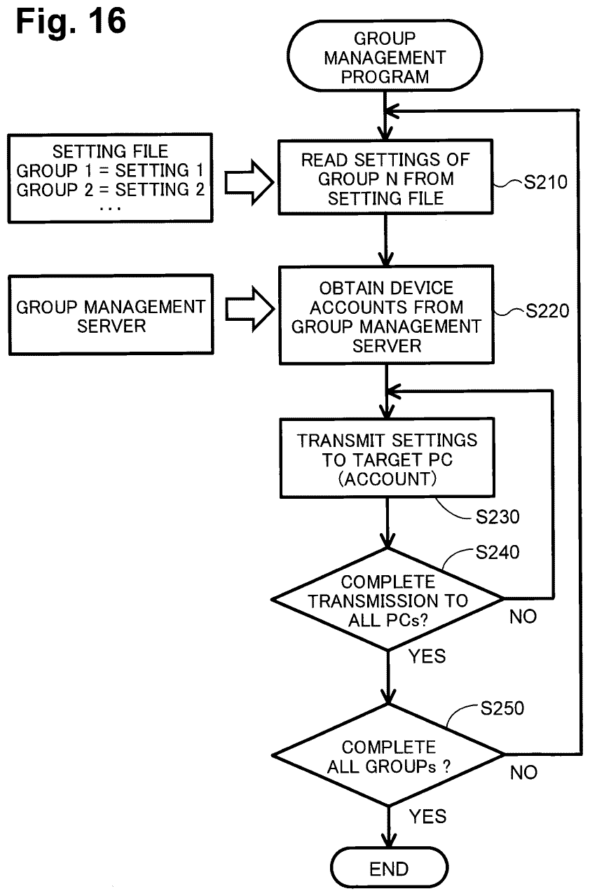

The management PC 400 sets or updates the rule files on each terminal device 100B by transmitting the rule files to each terminal device 100B. An example of the control procedure executed by the processor 410 of the management PC 400 during this process is illustrated in the flowchart of FIG. 16. In this embodiment, for example, multiple terminal devices 100B are managed by groups, and the rule files for each terminal device 100B are also managed by these groups. The groups can be configured based on companies, departments, or affiliated groups to which the users of the terminal devices 100 belong. Alternatively, the groups may be set according to group affiliations in domain management or OS group management. The processor 410 of the management PC 400 executes the flowchart shown in FIG. 16 by running a group management program.

In step S210 of FIG. 16, the processor 410 of the management PC 400 (see FIG. 21, described later) reads the configuration file for group N (N=1, 2, . . . ). The configuration file is the rule file for each terminal device 100B managed by group. For example, the rule file for each terminal device 100B belonging to group 1 is managed as configuration file 1, and the rule file for each terminal device 100B belonging to group 2 is managed as configuration file 2, and so on. The processor 410 reads the configuration files for all groups that are the target of transmission.

Each rule file that constitutes the configuration file may be generated by the management PC 400 or by external terminals or external servers other than the management PC 400. When the rule file is generated using the management PC 400, for example, the rule file is generated by an administrator, who is the user of the management PC 400, setting it on the rule file configuration screen displayed on the display 440 of the management PC 400 (see FIG. 21, described later). The generated rule file is stored, for example, in the data storage area 432 of the non-volatile storage device 430 of the storage device 415 of the management PC 400 (see FIG. 21, described later). In this case, the process where the processor 410 of the management PC 400 generates the rule file is an example of function restriction information generation processing, the process of storing the generated rule file in the data storage area 432 is an example of function restriction information storage processing, and the data storage area 432 is an example of the storage.

In step S220, the processor 410 of the management PC 400 obtains the account of each terminal device 100B belonging to group N, which was read in step S210, from the group management server. This account represents the configuration account of group N. The group management server is a server that manages the accounts of each terminal device 100B by group affiliation. The group management server may be the management PC 400 itself, an external terminal set up separately from the management PC 400, or an external server that manages general group and permissions. The account is information indicating the destination for the rule file transmission, such as the IP address of the terminal device 100B. The account is an example of output destination information, and this step S220 is an example of output destination information acquisition processing.

In step S230, the processor 410 of the management PC 400 transmits the configuration file of group N, which was read in step S210, to the corresponding terminal devices 100B belonging to group N, based on the configuration account of group N obtained in step S220. The processor 310 uses the HTTP protocol to send the configuration file to the EWS 179 of the terminal device 100B. Steps S210 to S230 are an example of function restriction information output processing.

In step S240, the processor 410 of the management PC 400 determines whether the transmission of rule files to all terminal devices 100B belonging to group N has been completed. If the transmission to all terminal devices 100B has not been completed (step S240: No), the processor 310 returns to step S230 to transmit the rule file to the next terminal device 100B. The processor 410 repeats steps S230 and S240 until the transmission of rule files to all terminal devices 100B in group N is completed. If the transmission to all terminal devices 100B is completed (step S240: Yes), the processor 410 proceeds to the next step S250.

In step S250, the processor 410 of the management PC 400 determines whether the transmission of rule files to all groups read in step S210 has been completed. If the transmission to all groups has not been completed (step S250: No), the processor 410 returns to step S210. The processor 410 repeats steps S210 to S250 until the transmission of rule files to all groups is completed. If the transmission to all groups is completed (step S250: Yes), the processor 410 concludes this flowchart.

### Effects of the Third Embodiment

The printing system 1 of the third embodiment includes a terminal device 100B configured to communicate with a printer 200 and a management PC 300 configured to communicate with the terminal device 100B. The processor 410 of the management PC 400 executes steps S210 to S230 to output a rule file to the terminal device 100B, which is used to restrict the printing functions of the printer 200. The processor 110 of the terminal device 100B (see FIG. 20, described later) acquires attributes representing the capabilities of the printer 200 and retrieves the rule file output by the management PC 400. The processor 110 converts the acquired attributes into restricted attributes according to the rule file and outputs the restricted attributes to CUPS 160. The processor 110 obtains print data from CUPS 160 corresponding to the restricted attributes and transmits the converted print data to the printer 200. By executing these processes, a virtual printer for CUPS 160 is formed on the terminal device 100B, enabling printing using the OS printing function without a driver.

According to the third embodiment, for example, the administrator of the printing system 1 can use the management PC 400 to set or modify rule files to restrict the printing functions of the printer 200. This embodiment provides user-friendly print restriction features for administrators in environments utilizing driverless OS printing functions.

Additionally, in the third embodiment, the management PC 400 has a data storage area 432, and its processor 410 executes processes to generate rule files and store them in the data storage area 432. The processor 310 reads the rule files stored in the data storage area 432 and outputs the rule files to the terminal device 100B. Thus, the administrator of the printing system 1 can generate and store rule files using the management PC 400. This embodiment offers a convenient print restriction feature for administrators.

In the third embodiment, the printing system 1 includes at least one terminal device 100B, and the processor 410 of the management PC 400 outputs the corresponding rule files to each terminal device 100B. This allows the administrator of the printing system 1 to use the management PC 400 to set or modify the corresponding rule files for at least one terminal device 100B simultaneously. This embodiment provides a user-friendly print restriction feature for administrators.

Additionally, in the third embodiment, the processor 410 of the management PC 400 executes step S220 to obtain the account, which is the output destination information for the rule files. In step S230, based on the account obtained in step S220, the processor 410 outputs the corresponding rule files to each terminal device 100B. This allows the administrator to use the management PC 400 to obtain the account of at least one terminal device 100B and set or modify the corresponding rule files for at least one terminal device 100B simultaneously. This embodiment offers a convenient print restriction feature for administrators.

In the third embodiment, the IPP/mDNS server 173 sends inquiry information to each of at least one printer 200, and the Attribute/mDNS converter 172 receives response information corresponding to the inquiry from each printer 200. The User Filter 172a outputs the response information from the printers 200 that are subject to function restrictions by the rule file to CUPS 160, while not outputting the response information from printers 200 that are not subject to restrictions. According to the third embodiment, when inquiries are made to each printer 200 via multicast DNS and response signals are received, only the response information from the printers 200 targeted by the rule file can be output to CUPS 160. This allows CUPS 160 to recognize only the printers 200 targeted by the rule file as the processing targets.

In the third embodiment, the printer application 170 converts the print data obtained from CUPS 160 into print data according to the rule file in the Print Data converter 174, and the converted print data is sent to the printer 200 via the Printer Communication unit 171. This embodiment allows for function restrictions that CUPS 160 cannot handle or provides higher quality restrictions than CUPS 160. For example, if printing is restricted to black and white, color print data output from CUPS 160 is converted to black and white print data. In this case, the Attribute/mDNS converter 172 keeps the attribute as color printing. Alternatively, the Attribute/mDNS converter 172 can convert the attribute to black and white printing, and a process to improve the quality of the black and white print data output from CUPS 160 can be executed.

### Modification Example

The third embodiment can be variously modified without departing from its spirit and technical concept.

(1) Methods for Transmitting Rule Files Other than EWS

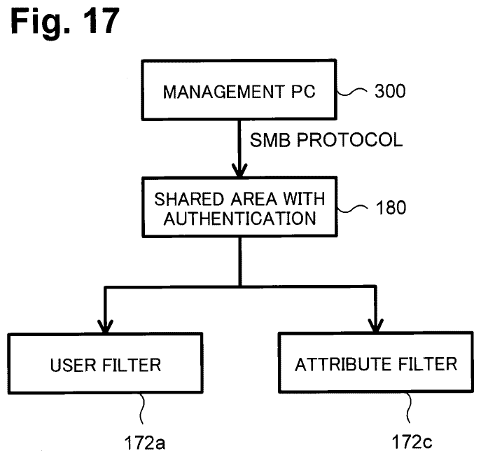

In the described embodiment, the rule file is sent to the EWS 179 of the terminal device 100B using the HTTP protocol in step S230 shown in FIG. 16. However, the method for transmitting the rule file is not limited to the HTTP protocol. For example, as shown in FIG. 17, the rule file can be transmitted using the SMB (Server Message Block) protocol, which is a file-sharing protocol in the OS 101 of the terminal device 100B. In this case, the processor 410 of the management PC 400 can write or update the rule file in the authenticated shared area 180 of the terminal device 100B by transmitting the rule file to the authenticated shared area 180. The rule file in the authenticated shared area 180 is output to the user filter 172a and the attribute filter 172c.

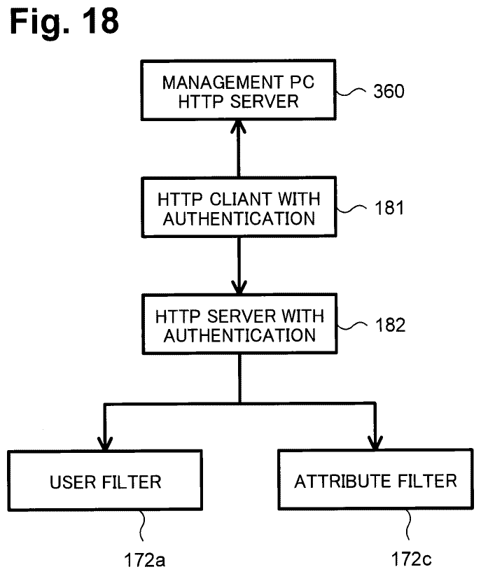

Additionally, as shown in FIG. 18, for example, the management PC 400 may have an HTTP server 360, and the terminal device 100B may have an authenticated HTTP client 181 and an authenticated HTTP server 182. In this case, the HTTP client 181 periodically sends requests for the rule file to the HTTP server 460 of the management PC 400. The HTTP server 460, in response to the request, sends the rule file to the HTTP client 181 using the HTTP protocol. The HTTP client 181 then sends the received rule file to the authenticated HTTP server 182. This setup allows the rule file to be written or updated in the authenticated HTTP server 182. The rule file in the authenticated HTTP server 182 is output to the user filter 172a and the attribute filter 172c.

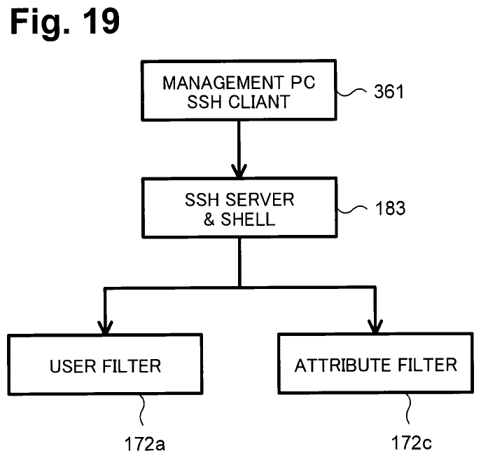

Furthermore, as shown in FIG. 19, the rule file can also be transmitted using the SSH (Secure Shell) protocol. In this case, the management PC 400 has an SSH client 361, and the terminal device 100B has an SSH server and shell 183. The processor 410 of the management PC 400 can write or update the rule file in the SSH server and shell 183 by transmitting the rule file from the SSH client 461 to the SSH server and shell 183 of the terminal device 100B. The rule file in the SSH server and shell 183 is output to the user filter 172a and the attribute filter 172c. Additionally, the FTP protocol can also be used.

In the modification examples described above, the processor 410 of the management PC 400 performs at least one of the following in step S230 shown in FIG. 16: writing to the authenticated shared area 180, writing within the authenticated HTTP server 182, writing within the SSH server and shell 183, or writing using the FTP protocol. According to this modification example, it is possible to write the rule file to the terminal device 100B using various communication protocols.

### (2) Others

Additionally, during the execution of the aforementioned PnP, the CUPSPnP manager 162 of CUPS 160 may automatically change the names of printers (including virtual printing devices) detected using protocols such as mDNS/SD and register the changed names of printers in CUPS 160. For example, a model number name like “XX-YYYYYY” could be changed to “Printer for Mr./Ms. XX,” or names based on locally connected PC names, login names, or group names managed by Active Directory could be used.

Furthermore, the rule file may include rules that are commonly applied to all users of printer 200, or it may include rules that are individually applied to each user using printer 200. The rule file may contain rules applicable to functions that can be restricted by CUPS 160, as well as rules applicable to functions that can be restricted through the conversion of print data. Additionally, the rule file may include rules that are applied individually to each terminal rather than each user.

Moreover, the third embodiment is described in the context where printer 200 supports the IPP protocol, but the invention can also be applied when printer 200 does not support the IPP protocol. In such cases, for example, a PPD (PostScript Printer Description) file pre-installed as a driver from printer 200 can be read and converted into a PPD file that restricts certain printing functions of printer 200 according to the rule file. A configuration combining both approaches is also possible. Specifically, the printer application 170 may be configured to include both the Attribute/mDNS converter 172 and the Print Data converter 174, along with a unit for converting the PPD file. This allows users to utilize printers that support IPP and those that do not, without distinction, while still benefiting from print restriction features.

In the third embodiment, the conversion of both attributes and print data according to the rule file was described, but it is not limited to this. For example, attributes may be converted without relying on the rule file, or attributes may not be converted at all, while print data is converted according to the rule file. Conversely, print data may be converted without relying on the rule file, or print data may not be converted at all, while attributes are converted according to the rule file. Conversion of attributes not based on the rule file refers to excluding attributes that CUPS 160 cannot process, for instance, because they include capabilities of printer 200 that CUPS 160 cannot handle. Conversion of print data not based on the rule file refers to converting print data to implement functions that CUPS 160 cannot support using printer 200. Additionally, conversion to accommodate the protocol of the print data sent to printer 200 is also a conversion not based on the rule file.

Additionally, the flowcharts shown in FIGS. 14 to 16 do not limit the invention to the procedures indicated in these flows. Steps may be added, removed, or reordered without departing from the spirit and technical concept of the invention. Furthermore, aside from what has already been described, the methods from the above embodiments and variations may be combined and used as appropriate. While not exhaustively exemplified, various modifications can be made to the invention without departing from its spirit, and it may be implemented in numerous ways.

### <Hardware Configuration of Terminal Device, Printer, and Management PC>

An example of the hardware configuration of the terminal device 100B and printer 200 will be described with reference to FIG. 20. In FIG. 20, components that are the same as those in FIG. 10 of the first embodiment are denoted by the same reference numerals.

### <Terminal Device>

As shown in FIG. 20, the terminal device 100B includes a processor 110, a storage device 115, a display 140, an operation unit 150, and a communication interface 190. These components of the processor 110, storage device 115, display unit 140, operation unit 150, and communication interface 190, are connected via a bus 105, enabling them to send and receive data to and from each other.

The storage device 115 comprises a volatile storage device 120 and a non-volatile storage device 130. The volatile storage device 120, such as DRAM, stores various programs and data to be processed. The non-volatile storage device 130, which could be a hard disk drive or a solid-state drive, includes a program storage area 131 and a data storage area 132.

The program storage area 131 stores various programs, including print processing programs based on the flowcharts in FIGS. 14 and 15 mentioned earlier. The data storage area 132 holds data necessary for executing these various programs.

The processor 110 is a data processing device, such as a CPU, that executes the various programs stored in the program storage area 131. The processor 110 performs various processes, including data communication with the management PC 400 and printer 200 connected to the network NT. The processor 110, along with the program corresponding to the printer application 170 stored in the program storage area 131, constitutes an example of the first controller.

The display 140, such as an LCD display, can present various types of information. The operation unit 150, such as a mouse or keyboard, accepts user operations. By using the operation unit 150, the user can input various commands into the terminal device 100B.

The communication interface 190 is a wired or wireless network interface used for communicating with other devices and is connected to the network NT.

It should be noted that the storage device 115 is not limited to the components described above. For example, it may be configured using RAM, ROM, EEPROM, HDD, portable recording media such as USB memory that can be attached to or detached from the terminal device 100B, buffers provided by the processor 110, or combinations thereof. Additionally, the storage device 115 may be a computer-readable storage medium. A computer-readable storage medium refers to a non-transitory medium. Non-transitory media include, in addition to the examples mentioned above, recording media such as CD-ROMs and DVD-ROMs. Moreover, non-transitory media are also tangible media. The same applies to the storage device 215 of the printer 200 and the storage device 415 of the management PC 400, which will be described later.

### <Printer>

As shown in FIG. 20, the printer 200 includes a processor 210, a storage device 215, a display 240, an operation unit 250, a communication interface 270, and a printing unit 290. These components of the processor 210, storage device 215, display 240, operation unit 250, communication interface 270, and printing unit 290, are connected via a bus 205, enabling them to send and receive data to and from each other.

The storage device 215 comprises a volatile storage device 220 and a non-volatile storage device 230. The volatile storage device 220, such as DRAM, includes an image data storage area 222 for storing image data to be printed. The non-volatile storage device 230, which could be NVRAM, flash memory, or the like, includes a program storage area 231 and a data storage area 232. The program storage area 231 stores various programs, including firmware such as print processing programs. The data storage area 232 stores various data necessary for executing these programs.

The processor 210 is a device for data processing, such as a CPU. It executes various programs stored in the program storage area 231.

The display 240, such as an LCD display, can present various types of information. The operation unit 250 is a device that accepts user input. By using the operation unit 250, the user can input various commands into the printer 200. The communication interface 270 is a wired or wireless network interface used for communicating with other devices and is connected to the network NT.

The printing unit 290 prints images onto sheets conveyed by a transport mechanism (not shown). Based on print data sent from the terminal device 100B or print jobs generated by operations on the operation unit 250, the printing unit 290 prints images onto the sheets.

### <Management PC>

As shown in FIG. 21, the management PC 400 includes a processor 410, a storage device 415, a display 440, an operation unit 450, and a communication interface 490. These components of the processor 410, storage device 415, display 440, operation unit 450, and communication interface 490, are connected via a bus 405, enabling them to send and receive data to and from each other.

The storage device 415 comprises a volatile storage device 420 and a non-volatile storage device 430. The volatile storage device 420, such as DRAM, stores various programs and data to be processed. The non-volatile storage device 430, which could be a hard disk drive or a solid-state drive, includes a program storage area 431 and a data storage area 432.

The program storage area 431 stores various programs, including group management programs and information processing programs based on the flowchart in FIG. 16 mentioned earlier. The data storage area 432 holds data necessary for executing these programs.

The processor 410 is a data processing device, such as a CPU, that executes various programs stored in the program storage area 431. The processor 410 performs various processes, including data communication with terminal devices like terminal device 100B connected to the network NT. The processor 410, along with the programs stored in the program storage area 431, constitutes an example of the second control unit.

The display 440, such as an LCD display, can present various types of information. The operation unit 450, such as a mouse or keyboard, accepts user input. By using the operation unit 450, the user can input various commands into the management PC 400.

The communication interface 490 is a wired or wireless network interface used for communicating with other devices and is connected to the network NT.

What is claimed is:

1. A non-transitory computer-readable storage medium storing an information processing program executable by a processor of an information processing device being loaded with an operating system (OS) that includes OS standard printing software, the information processing program being configured to, when executed by the processor in a state where the information processing program is registered as a virtual printing device in the OS standard printing software, cause the information processing device to perform operations comprising:
obtaining first capability information indicating capability of a printing device;
obtaining function restriction information of the printing device;
based on the obtained function restriction information, converting the obtained first capability information into second capability information;
outputting the second capability information obtained in the converting to the OS standard printing software;
obtaining, from the OS standard printing software, first print data corresponding to the second capability information outputted in the outputting; and
transmitting, to the printing device, second print data based on the first print data obtained from the OS standard printing software.

2. The non-transitory computer-readable storage medium according to claim 1,
wherein the function restriction information includes first restriction information, and
wherein, in the converting, the first capability information is converted into the second capability information based on the first restriction information.

3. The non-transitory computer-readable storage medium according to claim 2,
wherein the first restriction information is commonly applied to all users of the printing device.

4. The non-transitory computer-readable storage medium according to claim 1,
wherein the operations further comprise converting the first print data obtained from the OS standard printing software into second print data, based on the obtained function restriction information.

5. The non-transitory computer-readable storage medium according to claim 4,
wherein the function restriction information includes second restriction information, and
wherein, in the converting the first print data, the first print data is converted into the second print data based on the second restriction information.

6. The non-transitory computer-readable storage medium according to claim 5,
wherein the second restriction information is individually applied to users of the printing device.

7. The non-transitory computer-readable storage medium according to claim 5,
wherein the operations further comprise determining whether the first print data falls outside the second restriction information.

8. The non-transitory computer-readable storage medium according to claim 7,
wherein, when it is determined in the determining that the first print data falls outside the second restriction information, the first print data is transmitted to the printing device without being converted.

9. The non-transitory computer-readable storage medium according to claim 7,
wherein, when it is determined in the determining that the first print data dese not falls outside the second restriction information, the first print data is converted into the second print data and the second print data is transmitted to the printing device.

10. The non-transitory computer-readable storage medium according to claim 7,
wherein, the operations further comprise outputting a notification signal to notify a corresponding error when it is determined in the determining that the first print data dese not falls outside the second restriction information.

11. The non-transitory computer-readable storage medium according to claim 10,
wherein, the operations further comprise, after the outputting the notification signal, receiving a user selection whether to cancel printing or convert the first print data.

12. A non-transitory computer-readable storage medium storing an information processing program executable by a processor of an information processing device being loaded with an operating system (OS) that includes OS standard printing software, the information processing program being configured to, when executed by the processor in a state where the information processing program is registered as a virtual printing device in the OS standard printing software, cause the information processing device to perform operations comprising:
obtaining first capability information indicating capability of a printing device;
obtaining function restriction information of the printing device;
outputting the obtained first capability information to the OS standard printing software;
obtaining, from the OS standard printing software, first print data corresponding to the first capability information outputted in the outputting;
based on the function restriction information of the printing device, converting the first print data obtained from the OS standard printing software into second print data; and
transmitting the second print data to the printing device.

13. An information processing system comprising a first information processing device and a second information processing device communicable with the first information processing device, the first information processing device being loaded with an operating system (OS) that includes OS standard printing software and including a first controller configured to operate as a virtual printer corresponding to a printing device, the second information processing device including a second controller,
wherein the second controller is configured to perform:
outputting function restriction information of the printing device to the first information processing device,
wherein the first controller is configured to perform:
obtaining first capability information indicating capability of a printing device;
obtaining the function restriction information outputted from the second information processing device;
outputting the second capability information based on the first capability information to the OS standard printing software;
obtaining, from the OS standard printing software, first print data corresponding to the second capability information outputted to the OS standard printing software;
transmitting second print data based on the first print data to the printing device; and
at least one of (1) converting the first capability information into the second capability information based on the function restriction information and (2) converting the first print data into the second print data based on the function restriction information.

14. The information processing system according to claim 13,
wherein the second information processing device further includes a storage, and the second controller is configured to further perform:
generating the function restriction information; and
storing the function restriction information into the storage,
wherein, in the outputting function restriction information, the function restriction information is read from the storage and outputted to the first information processing device.

15. The information processing system according to claim 13,
wherein information processing system comprises a plurality of the first information processing device,
wherein the second information processing device further includes a storage, and the second controller is configured to further perform:
generating the function restriction information; and
storing the function restriction information into the storage,
wherein, in the outputting function restriction information, one of a plurality of set of the function restriction information corresponding to one of the plurality of the first information processing device is outputted to the one of the plurality of the first information processing device.

16. The information processing system according to claim 13,
wherein the second controller is configured to further perform:
obtaining destination information indicating a destination to output the function restriction information,
wherein, in the outputting function restriction information, the one of a plurality of set of the function restriction information corresponding to the one of the plurality of the first information processing device is outputted to the one of the plurality of the first information processing device, based on the obtained destination information.

17. The information processing system according to claim 16,
wherein, in the outputting function restriction information, the one of a plurality of set of the function restriction information corresponding to the one of the plurality of the first information processing device is outputted to the one of the plurality of the first information processing device, by executing at least one of:
writing the function restriction information into authenticated shared storage; and
writing the function restriction information into HTTP server.

18. The information processing system according to claim 13,
wherein the first controller is configured to further perform:
transmitting inquiry information to the printing device;
receiving response information transmitted from the printing device; and
output process of outputting the response information if the printing device is subject to the function restriction information and not outputting the response information if the printing device is not subject to the function restriction information.

19. The information processing system according to claim 13,
wherein, in the transmitting the second print data to the printing device, the first print data is converted into the second print data based on the function restriction information.
